(19) United States
(12) Patent Application Publication
(10) Pub. No.: US 2008/0154749 A1
(43) Pub. Date: Jun. 26, 2008

(54) Integrated System and Method for Improved Product Substance Compliance

(75) Inventors: Dries D'hooghe, San Jose, CA (US); Shankar Muthan, San Jose, CA (US); Kandasamy Sethuraman Kaliappan, San Jose, CA (US); Yao Chen, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Agile Software Corporation, San Jose, CA (US)

(21) Appl. No.: 11/779,200

(22) Filed: Jul. 17, 2007

Related U.S. Application Data
(60) Provisional application No. 60/877,067, filed on Dec. 23, 2006.

(51) Int. Cl. G06Q 10/00

(52) U.S. Cl. 705/28

(57) ABSTRACT

The invention is directed to a computerized system and method to allow manufacturers to ensure that their products are free of environmentally undesirable substances, such as toxic elements and chemicals, and thus comply with government substance regulations. The computerized system allows manufacturers to integrate substance information that is relevant to government substance regulations into an overall product lifecycle management system that makes this information immediately available to product design, manufacturing, purchasing, quality assurance, sales and regulatory personnel, thus facilitating production of environmentally compliant products.

### RELATED APPLICATIONS

This application Claims the priority benefit of provisional application Ser. No. 60/877,067 “System and Method for Improved Product Substance Compliance”, filed Dec. 23, 2006. The contents of application Ser. No. 60/877,067 are incorporated herein by reference.

### BACKGROUND

The invention is directed to a computerized system and method to allow manufacturers to ensure that their products are free of environmentally undesirable substances, such as toxic elements and chemicals, and thus comply with various government substance regulations. The computerized system allows manufacturers to integrate substance information that is relevant to government substance regulations into an overall product lifecycle management system, and makes this information immediately available to product design, manufacturing, purchasing, quality assurance, sales and regulatory personnel, thus facilitating production of environmentally compliant products.

Many modern products, such as electronic devices, transportation devices, dwellings, medical equipment, food and drugs are built up from a variety of different components and component materials. Although most of these components and component materials are harmless, some have undesirable secondary characteristics such as toxicity or environmental damage. In some cases, these undesirable characteristics are a known property of the material. Users purchase the material knowing of the inherent undesirable characteristics, and both expect and are legally obligated to handle and dispose of the material properly. As an example, a purchaser of gasoline or weed killer is usually under no illusions that the material is non-toxic, because the undesirable characteristics of the material are immediately evident upon casual inspection.

In many cases however, the undesirable secondary characteristics of a given material may be hidden or not immediately evident. As an example, a purchaser of a television monitor usually will have no idea that the monitor may contain environmentally toxic substances hidden in the various electrical components of the monitor's circuitry.

As knowledge of toxicology, analytical chemistry, ecology and the environment has advanced, it has become increasingly clear that a number of industrially useful chemicals and elements can produce delayed, subtle, or unexpected undesirable effects, such as environmental damage or toxicity. In many cases, these problems only became evident when large amounts of products containing such materials were produced and then discarded. As these products accumulated in waste dumps, the undesirable materials were released into the environment, producing harmful effects to humans, wildlife, and vegetation.

Throughout this document, materials that are found to exhibit such undesirable characteristics, such as toxicity or environmental damage, are often referred to as “hazardous substances”, “undesirable substances” or “substances of regulatory interest” often abbreviated as simply “substances”.

Unfortunately the sip lest solution—immediately discontinuing use of undesirable substances when their negative characteristics are discovered, isn't usually practical. It usually takes many decades to prove that a substance is exhibiting undesirable secondary characteristics. Often, by the time that the problem is discovered, the substance has become so deeply engrained into various industrially important processes and products as to make substitution extremely difficult. In many cases, when manufacturers first attempt to switch to more environmentally acceptable substitute materials, they find that the products may become inadequate or significantly more expensive to produce. Often it takes a significant amount of development time and expense to successfully make the transition to a more acceptable material.

The costs of removing substances that are found to have hidden undesirable characteristics are usually borne by the manufacturer, and are passed to the user in the form of higher prices. Such costs can often be substantial. By contrast, the benefits of removing undesirable substances do not usually convey any immediate benefit to either the manufacturer or the immediate user. In the long term, these benefits may also be substantial, and may include preservation of the environment, protection of the health of residents near waste dumps, and long term prevention of cancer or learning disorders in children. However in the short term, these benefits are usually not immediately evident to either the manufacturer or user of a product, and thus are easy to overlook.

Because of this disconnect between cost and benefit, the problem of coping with products that contain undesirable substances has typically been dealt with at a governmental level. Often this is appropriate, because governments are both charged with the responsibility of looking out for the interests of society as a whole, and also have the ability, through regulations, taxes, and penalties, to ensure compliance. As evidence that some materials have hidden undesirable effects has accumulated, governments throughout the world have responded with various types of product manufacturing and disposal regulations designed to minimize the risks to regional populations and environments.

A number of such regulations presently exist, and many more are in the process of being enacted. These include the European Union's Restriction of Hazardous Substances (RoHS), the Waste from Electrical and Electronic Equipment (WEEE), the Chinese Regulation for Pollution Control of Electronic Products, and the California Electronic Waste Recycling Act. In this document, although the RoHS and WEEE regulations are often used as specific examples of material regulations, it should be understood that the art is general purpose, and can be applied to a wide variety of alternative product environmental regulations as well.

Examples of specific elements and chemicals that may be regulated under one or more of these regulations include lead, cadmium, mercury, hexavalent chromium, polybrominated biphenyl (PBB), and polybrominated diphenyl ether (PBDE) flame retardants. Other lists can include Joint Industry Guide (JIG) A, B, C lists, or custom substance lists.

Categories of equipment regulated under one or more of these regulations include large household appliances, small household appliances, information technology and telecommunication equipment, consumer equipment, lighting equipment including light bulbs and fluorescent tubes in households, electrical and electronic tools, toys leisure and sports equipment, medical devices, monitoring and control equipments, and automatic dispensers.

Exemptions to such regulations can include consumables such as printer ink cartridges, photocopier and laser printer toner, satellite box control cards, fixed installations such as elevators, domestic electrical supply systems, or escalators, military and national security equipment such as arms, munitions, and war material, components intended to be used in airplanes, boats, cars or other forms of transport.

When a product has a small number of parts made by a small number of suppliers (vendors), the accounting and data management capabilities needed to ensure compliance with various environmental regulations can also be relatively simple. Here prior art compliance monitoring methods, such as manual accounting methods, electronic spreadsheets, and simple computer databases, are generally adequate. However as product complexity grows, prior art compliance monitoring methods become less and less effective.

For better or worse, most governments have written their environmental regulations so as to place most of the product substance regulatory burden on the company that actually sells the product to end users. As a result modern electronics companies inherit some big compliance monitoring issues. If the parts in their products do not comply with government environmental regulations, then their products won't comply, and the company may face substantial fines or complete loss of a given market.

Consider the problems faced by many modern electronics companies operating in the United States or Europe. Many of these companies are “hollow” corporations that primarily focus their efforts on product design, marketing, and sales (usually selling on a worldwide basis); and they outsource most of their product manufacturing to vendors located in other countries.

As a result to these trends towards international hollow corporations selling products obtained from worldwide supply chains, the complexity of compliance monitoring can become almost nightmarish in scope. Modern products may be composed of hundreds or thousands of different parts, each part of which can be produced from manufacturers throughout the world. Each part may be composed of its own unique set of materials. Each material in each different part from each different vendor may have a “substance” with hidden undesirable effects. Some vendors may make a part that is environmentally acceptable, while alternate vendors may make the same type of part using different materials that are not environmentally acceptable. Vendors may switch materials in their parts, and don't always promptly notify their customers when this switch has occurred.

Modern electronics companies sell their products on a worldwide basis, and each region of the world may have its own unique set of environmental regulations. In every area of the world, local governments may randomly decide to audit the company's products, or competitors may decide to analyze a competing product for compliance, and turn in their competitors to local governments if the products are not compliant.

As a result, modern companies need to be able to prove, on a moment's notice that their products conform to local environmental regulations for a given region. Thus there is a compelling need for automated methods to enable companies to produce products that comply with various environmental regulations, do so in a cost-efficient manner, and provide audit trails demonstrating compliance with each region's regulations.

In addition to environmental regulatory management issues, modern companies have a wide variety of other product management issues to cope with. To stay competitive, new Products must be rapidly designed, the quality of the products must be assessed, and parts for the products must be purchased. The products must be sold to the proper markets, and customer feedback or complaints addressed by corrective action. The price of the product's components must be managed, and the lowest cost vendors that produce acceptable parts must be selected. Correct numbers of parts must be purchased, based on forecast demand, and manufacturing must produce adequate amounts of product to meet forecast demand. All of these disparate functions must be managed by accounting and upper management to ensure that the company as a whole operates profitably.

In order to handle this type of complexity, companies such as Agile Software Corporation, and other vendors, have introduced sophisticated computer systems that can collect data from various corporate departments and present the data in a way that lets the organization run its operations electronically. These systems, often called “Product Lifecycle Management” (PLM) systems, function by using data translation “middleware” that extracts data from each department's specialized software programs (e.g. the design department's various CAD system's the accounting department's financial software, various specialized databases and so on. The PLM system takes this multi-source data, collates it into a comprehensive database, and presents it to the organization in a form that allows authorized individuals full access to the data that they need to do their respective tasks, regardless of where the data originally came from. Thus a design engineer can get full access to accounting cost data for a particular product subcomponent, can see what the manufacturing yields are for that product, and can track customer complaints, and so on. Such PLM systems, such as the Agile 9 system produced by Agile Software Corporation, San Jose, Calif. greatly increase organizational effectiveness, and are presently on a rapid adoption curve worldwide. Examples of prior PLM art include U.S. Pat. Nos. 7,124,150 and 7,010,580.

Attempting to turn a product that does not comply with various environmental regulations into an environmentally acceptable “green” product can often be extremely expensive and time consuming. Usually the product must be redesigned, and alternative, environmentally acceptable components and/or vendors selected. The product must then undergo careful testing to insure that the basic functionality of the product has not been compromised by the substitute environmentally acceptable materials. Often problems can occur. As an example, lead, although environmentally problematic, is extremely useful in electronics. Indeed lead-free electronic components often fail at a higher than acceptable rate unless their design is carefully optimized.

The most cost effective way to insure environmental compliance is not as an environmental retrofit to existing products, but rather by designing products from the beginning to be environmentally compliant. In order to assist in this process, anew type of product lifecycle management software tool that would immediately supply product composition data and environmental regulation data to design engineers during the design process would be highly useful.

Product lifecycle management software that also provides product composition data and environmental regulation data to purchasing personnel would also be highly useful. At present, purchasing personnel primarily consider other factors, such as price, availability, and reliability in their purchasing decisions. Timely (instant) availability to environmental data would allow such personnel to make decisions that are in the best long-range interest of the company.

Additionally, an advanced product lifecycle manger tool that could allow compliance managers to audit design and purchasing decision, and warn about the adverse consequences of improper selections, would also be highly useful.

Although there have been a number of previous efforts to integrate environmental and regulatory data into material database systems, none have produced the comprehensive integrated design and management product lifecycle management system needed to produce optimal results. As will be seen, the invention provides such a system and method that produces improved results, and in an elegant manner.

### BRIEF DESCRIPTION OF THE DRAWINGS

FIG. 1 shows a flow chart of the process by which information pertaining to the composition of various parts and materials in a product are entered into the PG&C manager.

FIG. 2 shows an example PG&C regulatory input user interface being used to input or examine the maximum allowed amount (in parts per million) of various heavy metals permitted by a typical environmental regulation.

FIG. 3 shows an example PG&C material declaration user interface being used to enter or examine substances of regulatory interest for a particular part.

FIG. 4 shows a detail of the PG&C software linkages between a manufacturing part number, the material declaration linked to this part, the supplier of the part, substances of regulatory interest in the part, and various environmental regulations.

FIG. 5 shows a detail of the PG&C software linkages between the various types of compliance data for a part, illustrating the flow of compliance data between the various alternate ways of determining if a part is compliant.

FIG. 6 shows an overview of the strategy used to determine if a part is compliant (has less than the minimum PPM of various environmentally regulated substances) by breaking the part into subparts and calculating compliance for subparts.

FIG. 7 is an example PG&C substance declaration user interface showing how the various data fields are used by the PG&C algorithms to determine that a particular part is non-compliant in several of its constituents.

FIG. 8 shows an overview of the strategy used to determine if a product (a top level assembly composed of many parts) is compliant, by examining the product's bill of materials and determining if all the items in the bill of materials are compliant.

FIG. 9 is an example PG&C supplier part user interface showing how the various data fields are used by the PG&C algorithms to come up with an overall “compliant for the RoHS regulation, non-compliant for the WEEE regulation” assessment for a particular supplier part.

FIG. 10 shows an overview showing how the various compliance algorithms (Rollups) work together to summarize product data, and determine if a product is compliant.

FIG. 11 is a flowchart illustrating at a top level how the PG&C algorithms determine item compliance of an assembly or component.

FIG. 12 is a flowchart illustrating how the PG&C algorithms determine bill of material (BOM) compliance.

FIG. 13 is a flowchart illustrating how the PG&C algorithms determine approved manufacturer's list (AML) compliance.

FIG. 14 is a flowchart illustrating how the PG&C algorithms determine manufacturer p art compliance.

FIG. 15 is a flowchart illustrating how the PG&C algorithms check an approved vendors (suppliers) list (AVL) for compliance.

FIG. 16 is a flowchart illustrating how the PG&C algorithms check the compliance of one composition of a part with a new regulation, illustrating how information can be reused to check compliance with new regulations and specifications.

FIG. 17 is a flowchart illustrating how the PG&C algorithms check a submitted composition for compliance.

FIG. 18 is a flowchart illustrating how the PG&C algorithms perform calculations of mass and parts per million (PPM) of substances of regulatory interest.

FIG. 19 is a flowchart illustrating how the PG&C algorithms perform calculations of mass and PPM of substance groups.

FIG. 20 is a flowchart illustrating how the PG&C algorithms assess a bill of substances for compliance.

FIG. 21 is an example of how the PG&C substance of regulatory interest and compliance data can be used as part of a larger product lifecycle management system to quickly check compliance problems at the design or purchasing stage. Here the bill of materials of a computer product is displayed, and a listing of the bill of substances within the bill of materials is shown on the left.

### DETAILED DESCRIPTION OF THE INVENTION

The invention provides systems and methods for managing, tracking, validating and otherwise dealing with material or substance compliance in products, including in component parts, packaging, enclosures, and other aspects of a product where evaluation of such materials and substances is desired or required by government regulation.

One embodiment of the invention provides an electronic program and database designed to integrate a variety of different environmental regulations, a variety of product composition (design, bill of materials) data, and a variety of environmentally regulated materials information from suppliers, and integrate these environmental regulation data, product composition data, and supplier material information data in a way that allows users to instantly understand the regulatory impact of changes in product design, changes in vendors or vendor specifications, and changes in regulations on the regulatory status of products monitored by the invention. Throughout this disclosure, an embodiment of the invention will be referred to as a “Product Governance and Compliance Manager”, or “PG&C manager”.

Although the PG&C manager is useful at all stages of a product's life cycle, it is particularly useful at the design phase of a product. By integrating material composition data and environmental regulation data into the same produce lifecycle management system used by design engineers to design a product, design engineers can immediately see the environmental impact of their design decisions or choice of supplier, and avoid problems by choosing environmentally preferred components and suppliers. The system may also monitor designs and flag areas where environmental corrective action is needed.

The PG&C manager is also a closed-loop compliance corrective action system. The invention allows the user to take the user's product design, and break it down into subcomponents and suppliers. The invention scans the product for overall compliance with various environmental regulations, detects deviations from overall compliance, and allows users to correct these deviations through automatic requests for material content environmental information and declarations from the various product chain suppliers.

Although it can be used as a stand-alone software module, the invention may be integrated as a module in a larger product lifecycle manager enterprise software system. This embodiment allows environmental compliance data and regulations to be nearly effortlessly incorporated into an organizations other routine product design, purchasing, manufacturing, accounting, marketing, sales and distribution functions, and helps insure that the organization produces environmentally compliant products with high speed and efficiency.

In one embodiment, the invention is a product governance and compliance module (PG&C module) of a larger product lifecycle management (PLM) system. The PG&C module helps cross-correlate product material data with standards and government regulations, and in a larger PLM system can cross-correlate this with other product and corporate activities. This can include things such as environmental regulation standards (e.g. the Waste of Electronic and Electrical Equipment [WEEE] directive, the Restrictions of Hazardous Substance [RHOS] regulations), software validation tracking, and industry specialized government regulations such as FDA Quality System Regulations (21 CFR Part 820) regulations for medical device manufacturers.

### Review of PLM Methods

Generally, automated product lifecycle management (PLM) software systems are network data managers that allow users to exchange and view various types of business product information. This data can include product information such as design and development information, prototype and pilot production information, launch and ramp-up information, manufacturing production information, service and support information, and phase out and disposal information such as compliance with various governmental (green) waste disposal and recycling information.

In addition to this specific product data, PLM systems can also handle ancillary corporate and business functions, such as customer relationship data (CRM), enterprise resource financial planning data (ERP), Supply chain management (SCM) to manage the companies various suppliers, and human capital management (HCM) systems to manage the work and insurance records for the companies various employees.

Some of the specific data types handled by PLM systems include: product data, supply chain data, component part data, subcontracting company data, partnership data, design data, development data, access privilege data, trade secret data, confidential information data, business relationship data, business documents data, business agreements data, OEM products and components data, CEM products and components data, bill of material data, change order data, component part object data, component part linking data, component part identification data, component part number data, part attribute data, part affiliation data, part product context data, specifications drawing data, color data, size data, type data, price data, quantity data, find number data, cross-reference data, related information data, earlier version data, history of change data, text document data, graphics drawing data, other attribute data, redacted data, discovery privilege data, cost data, component parts specifications data, product specifications data, quantity received data, quantity needed data, availability data, supplier type data, geographical information, and purchase order data, program data, schedule data, resources data, critical path data, activities data, issues data, action items data, task data assignment data reports data and product deliverables data.

PLM systems often are configured as various modules. Some of these modules include:

Product portfolio management: This facilitates product development by coordinating program information and product information, balancing resource allocation and managing product deliverables, project status, project schedules, project costs, and project quality across an extended supply chain.

Product collaboration: This allows different organizations, such as original equipment manufacturers and their various subcontractors, to share product information throughout the world while at the same time keeping track of the status of the business relationships between the various organizations, and only sharing data in accordance with established business rules. Thus for example, different members of a product supply chain will have access to relevant information such as bills of material, product attributes, product configurations, product specifications, product documents, subcontractors involved, revisions and work instructions selectively, and as dictated by the level of the business relationship. For example, two comp eting subcontractors for a component may both be able to access the specifications part of the database, yet be locked out of the part of the database that gives access to the other competitor's bidding and performance history.

Engineering collaboration: Engineers use a variety of different computer aided design (CAD) systems each highly specialized and very appropriate to their individual tasks, yet very expensive to operate on a per-seat basis, and often quite incompatible with other CAD systems. PLM engineering collaboration modules allow engineers to integrate data from a variety of different mechanical design CAD (MCAD), electronics design CAD (ECAD), software and desktop publishing applications, located across the world, and instantly allow a user to access the right set of design data from a PLM server, often through a network (such as the Internet) using inexpensive user terminals such as Internet web browsers.

Product cost management: Business managers, accountants, production managers, and designers all need to understand various product costs in detail, and manage supply and delivery contracts effectively. This module usually contains cost, delivery, and contract data relevant to these efforts.

Product quality management: These PLM modules allow the company to insure customer satisfaction and conformance to government regulations by implementing a corrective action product quality monitoring system. Corrective action systems track customer complaints and sub-optimal product performance incidents, assign responsibility to various individuals to investigate the root cause behind each problem, and attempt to solve or mitigate the problem by initiating some sort of change to the product creation and management process that will hopefully solve the problem, or at least mitigate the severity of the problem.

Any organization that attempted to write completely new software that could handle this entire multitude of functions competently would face a task so complex as to be effectively impossible. Rather than attempting to do this impossible feat writing a comprehensive system composed entirely of new software, modern PLM software instead works largely as “middleware”. The PLM software uses many data translator and data transfer programs which translate and transfer data between preexisting data origination (“authoring”) programs (such as CAD systems, accounting programs, specialized product databases, and the like) and transfer this data to preexisting database management software, such as Oracle or SQL databases and the like. The PLM software coordinates all of these independent and pre-existing programs into a cohesive whole, and makes it easy for users to access these pre-existing programs through a single, network based, user interface (PLM interface).

Using the PLM interface, multiple users on a network can submit various queries and various types of data to the PLM. The PLM in turn consults its database to find out where the appropriate data is stored, processes the data, and presents the results of its processing to the user. Often the PLM will in turn translate the data back into a format that can be handled by the various authoring programs of origination. Thus a design engineer can submit a product design query to a PLM, the PLM, after consulting its database, will pull out the appropriate CAD files, and send this data to a version of the authoring CAD program that exists on the PLM server, rather than the user desktop. The CAD authoring program will itself interpret the CAD data file, and output a view of the drawing. The PLM program translates the CAD authoring program output into a format suitable for transmitting over a network, and capable of being displayed on a low-cost user computer (terminal) that does not, itself, have a copy of the CAD authoring program.

Using this technique, a single low-cost user terminal can gain access (through a network connection to a PLM server, which is usually in a different location) to essentially any set of data available to the enterprise, and manipulate this data, using only a very simple terminal that may consist of little more than a web browser and a network or internet connection. In addition to CAD files, many other types of files, such as authoring tools, spreadsheet tools, project management tools and other specialized software can be “run” on low-cost remote terminals on an as-needed basis. As per the CAD example, the main block of this specialized program code resides on the PLM server. The PLM takes remote user terminal queries, runs it on the instance of the authoring program running on the server, and then sends an image of the output to the remote viewer. Assuming a reasonably high bandwidth network and low to moderate latency, the final result from the standpoint of the remote user is that the particular authoring program needed to manipulate the requested data appears to be residing on the remote user's local computer.

In order to manage all of this data manipulation and translation, PLM systems employ a variety of different software integration techniques, including Extensible Markup Language (XML) and Java Message Service (JMS) as general purpose data translator and exchange tools; Product Data eXchange (PDX) for electronics bills of materials, approved manufacturer lists, engineering change orders, and material content information (useful for substance based compliance regulations such as ROHS, which may use one or more standards such as the IPC-1752 standards) as well as, Japanese Green Procurement (JGPSSI) standards, National Electronics Distributor Association (NEDA) standards, and RosettaNet PIPs 2A10 and 2A13 standards. Additional methods and standards include more general internet-based business data exchange standards; SOAP (Simple Object Access Protocol) for exchanging XML data using HTTP protocols that are compatible with a wide variety of web browser and network firewall environments; and Web Services Description Language (WSDL) language techniques that also enable various types of data protocols to exchange data between different types of programs using web protocols that generally cross firewalls without difficulty.

PLM software often also incorporates various analytical modules that can automatically generate reports and statistical summaries by pulling together data according to user specified frameworks.

From a business perspective, PLM systems serve as a delivery vehicle that allows an organization to easily access and manage the enormous variety of different data types necessary to operate a modern enterprise. Prior to the advent of PLM, such information was stored in a multitude of incompatible formats, often paper based, in a multitude of individual department “fiefdoms”. Data transmission across departmental and format boundaries was slow, prone to distortion, and sometimes even politically hazardous.

PLM systems help companies bring in revenue quicker, reduce costs, improve quality, ensure compliance with government regulations, and help facilitate innovation by instantly putting the right set of data in front of the right user at the right time.

Definitions:

Although tangible products and materials are composed of a wide variety of different atoms or chemicals, most of these different types of atoms and chemicals, such as carbon silicon, copper, or iron, usually do not need to be tracked for environmental regulatory compliance purposes. Throughout this document, standard chemical nomenclature has been somewhat altered to distinguish between atoms and chemicals that are believed to be toxic or somehow undesirable, and thus important from an environmental regulatory standpoint, “safe” atoms and chemicals. These “safe” atoms and chemicals, although important to the product, are not presently subject to environmental regulations because they are believed to be non-toxic or have not been otherwise identified as being undesirable. In many of the examples discussed here, the software of the invention simplifies its representation of complex products and materials by focusing its attention primarily on the elements and chemical compounds of regulatory concern, and ignoring elements and chemical compounds that are not of regulatory concern. This simplification step streamlines record keeping, and helps make the complex environmental regulatory management task logistically feasible.

A second deviation from standard chemical nomenclature is that for the purposes of this document, all calculations are done on a mass basis (pounds, tons, grams, kilograms, etc.), rather than in terms of the number of moles of the chemicals involved.

The following terms are used throughout this document, and unless exceptions are noted, it should be assumed that the invention follows the teaching and limitations implied by the following terms:

Agile Part—Although the invention may be used as a stand-alone software module, as previously discussed, in one embodiment, the invention exists as one or more modules in a larger product lifecycle management (PLM) software system. Suitable product lifecycle management (PLM) programs include the Agile Software Corporation PLM version 9.2 or higher, produced by Agile Software Corporation. In the present document, the use of the term “Agile part” means that the software is integrated into a PLM system, and is configured to exchange data with other elements of the PLM system.

Substance—Substances are chemical elements and their compounds. American Chemical Society CAS registry numbers, which are unique chemical identifiers for the substance, are provided for these substances where known. As previously discussed, this will be primarily focused on heightened concern chemical elements and their compounds. That is, chemical elements and compounds the customer or country (regulatory legal legislation) is officially “interested in” (i.e. may have a legal requirement to track, or a potential legal requirement to track), usually because of potential undesirability concerns. Thus, as previously discussed, although the standard usage of the term “substance” has no particular legal or regulatory implications, here the term “substance” generally is intended to convey that these particular atoms or compounds are believed to be undesirable if released into the general environment, and the term “of interest” is intended to remind the reader that this substance is associated with heightened regulatory and legal concerns. Occasionally, to make the distinction clearer, the term hazardous or undesirable substances will be used to clarify the meaning of the term.

Substance Group—A substance group is a group of similar substances that all share at least one “base” substance of regulatory interest in common. Substance groups are essentially lists (groups) of chemical compounds that contain a common substance “of interest” (e.g. regulatory concern) mixed together with other chemicals that may be of less concern from a regulatory standpoint. For example, a substance group called “lead and lead compounds” may have several chemicals such as lead-oxide, lead-nitrate, lead-sulfate etc. These compounds contain a substance of regulatory interest (lead) that is tied with other chemical elements such as oxygen to form compounds of the substance of regulatory interest (oxide, sulfate). Here, the substance “of interest” is termed “the base substance.” The amount of base substance of regulatory interest in each member of the group can be calculated through the mass of the respective group member multiplied by its particular conversion factor.

Here is one example of a substance group:

Cadmium and its compounds (base: Cadmium)

| Cadmium | 1.000 -- conversion factor |
|---|---|
| Cadmium oxide | 0.875 |
| Cadmium sulfide | 0.778 |

Material—As defined in this specification, a “material” is made up of one or more substances (e.g., copper alloy is a material, which in turn is made up of a number of defined substances, copper, nickel, silver, etc.). For computational purposes, a material is often considered to be made up only of substances and substance groups, and it should not contain (refer to) other materials, or substance groups. Materials are usually chemical that can be bought in bulk, such as a glue, resin, or alloy. For purposes of environmental compliance calculations, Materials are considered to contain two basic types of substances: intentionally added substances and non-intentionally added substances (contaminations). As an example, stainless steel contains 9% Nickel. Nickel is an intentional substance in stainless steel that makes it corrosion resistant. But during production, contaminants, such as lead, can enter due to impurities in the raw materials or manufacturing process. Typically the software will also be aware (track) that materials can vary according to their source and degree of mixture, and thus may have additional subclasses such as homogenous (or not), global source, and local source.

Sub-Part—A sub-part is made of one more materials.

Homogenous Material—a material that cannot be mechanically disjointed into different materials.

Product—the item that the respondent is supplying (e.g., assembly, subassembly, component, raw material).

Threshold level—Concentration level, which defines the limit, above which the presence of a substance or material in a product or subpart must be declared based on the requirements of the regulation.

Substance Mass—weight of the substance

Substance PPM—substance measured in Parts-Per-Million, also known as “concentration”. As an example: a part contains a substance, which has 500,000 PPM. This implies that the mass of the substance is 50% of the total part weight: i.e. 500,000/1,000,000.

Agile Part—refers to an Agile software “object:” It can be one of the following objects: item, manufacturer part, and part family. Here an “object” is a group of related data connected by software linkages that is often transferred or manipulated as a whole, and is usually intended to be the software representation of important data associated with a particular part.

Compliance Status—indicates if an object is compliant for a given specification. It can be one of the following values (in the order of the best to the worst):
Not Applicable
Compliant
Exempt (i.e. Pass with Exemption)
Waiver in Place
Unknown (i.e. Missing information)
Non-Compliant

Compliance Status Priority (i.e. best vs. worst)—the status of any higher level in the Bill of Substance or Bill of Material above the current level cannot be lower than the status of the current level. The ‘Non-Compliant’ status has the highest priority, and the ‘Compliant’ or “Not Applicable” status has the lowest priority. That is, if the lower levels are compliant, the higher level must be compliant.

Compliance Status Types—compliance can be established ways. First of all, a supplier or user can simply declare an item to be compliant. This declaration usually carries some legal weight or consequences, and thus is not something to do lightly. Secondly compliance can be calculated by summing up all of the items constituents. Thirdly compliance can be calculated by a mixture of declared and calculated compliance.
Declared Compliance—a user entered compliance status
Calculated Compliance—a calculated compliance status based on the substance data of the part, or the rollup status of its child parts.
Result Compliance—This is the final rollup result. If there is a declared compliance, the rollup result uses the declared compliance. Otherwise, it uses the calculated compliance. The declared compliance supersedes the calculated compliance.

Bill of Materials (BOM)—BOM contains the top-level assembly, assembly part numbers, and manufacturer part numbers for a given product or high level product component.

Bill of Substances (BOS)—BOS is a substance composition on an Agile part—i.e. an item from a bill of materials that has been entered into a PLM, such as an Agile PLM. The BOS can contain sub-parts, materials, substance groups, and substances.

Composition—A composition is the bill of substance (BOS) data supplied by a given supplier (usually in response to a query from a compliance manager who is using the invention) for response for a given specification for an Agile part. Composition information includes type, source (i.e. supplier or third party name), name of composition, specification identifier, date stamp, environmental declaration, calculated compliance, declared compliance, weight, historical data, date effective, and linking information.

AVL—approved vendors list (for apart)

AML—approved manufacturer's list (for a part)

IPC-1752—an XML based standardized computer data exchange format for electronics companies to exchange materials content data for their components and assemblies

Specifications: Specifications are a list (database object) of the items characteristics, and may include a list of substances of concern, and for each substance a threshold value identified in parts per million (PPM), as well as the exemptions allowed by that specification.

“all specs” composition—In some cases, a supplier may simply give the item's overall element and chemical makeup as a “parts per million” (PPM) declaration, but not declare if the item is in compliance with a particular set of regulations. In this case, the composition documentation is the to be an “all specs” composition, meaning that the information within the composition can be used with multiple specifications to assess compliance.

The Product Governance and Compliance Invention

In one embodiment, the invention provides a system and method for validating substance compliance of a product. Such a system includes substance storage for storing substance related data used in a product, product storage configured to store data related to product components and substances that make up the respective components, and a compliance database having data related to predetermined substance compliance criteria and compliance status information. Typically the storage means will be a computer mass data storage means, such as random access memory, magnetic disk or hard drive storage, optical storage, magnetic tape storage, or other computer mass data storage means.

The compliance database may be based on one or more commercially available databases, such as an Oracle database. This database may include a “roll up engine” set of computer algorithms configured to collate and analyze product substance data of a product of interest according to the data related to the product component information in the product storage and according to the corresponding product substance related data in the substance storage, and a validity engine set of computer algorithms configured to determine whether the predetermined substance compliance criteria have been met. The roll up engine may also roll up compliance status information as well.

The substance storage may include substance data related to product components and individual substances and materials that make up the components. The substance storage may further include substance data related to product packaging and individual substances that make up the product packaging.

The invention may contain an analysis or “roll up” software capability configured to generate substance quantity values that pertain to the amount of individual substances of regulatory interest that are contained in a product. Alternatively, the roll up engine may be configured to generate substance quantity values that pertain to the weight of individual substances contained in a product.

The invention may also contain a software “validity engine” configured to ascertain the amount of a substance of interest in a product and to compare the ascertained amount of the substance to a predetermined compliance threshold to determine whether the product is compliant with respect to the substance of interest. The validity engine may further be configured to calculate a best case amount of a substance and a worst case amount of a substance contained in a product for comparison with the compliance threshold. The validity engine may further be configured to calculate a best case amount of a substance and a worst case amount of a substance contained in a product for comparison with the compliance threshold, and is further configured to generate a request for a compliance corrective action if the amount of the substance contained in the product is above a predetermined threshold.

Many regulations focus on how a particular product should be handled at the end of the products life. That is, how the product should be recycled or reused once the primary user is done with the product. Often manufacturers are responsible for ensuring that at least the majority of the product is reused or recycled according to regulations. This may include providing means, such product pick-up centers, recycling stations, return mail means, etc., for ensuring proper reuse.

The invention may also provide a “reuse database” that includes a reuse tracker configured to track substances contained in a component, and a validity engine configured to determine whether the predetermined substance compliance criteria have been met. The reuse database may be configured to ascertain component substance quantities of undeclared substances, or may be configured to ascertain component substance quantities according to predetermined statements made by the component producer.

The invention still further provides a system for validating substance compliance of a product, where corrective actions are initiated in order to correct problems, deficiencies or other changes to a product process in response to such issues. Such a system may include substance storage for storing substance related data used in a product and product storage configured to store data related to product components and substances that make up the respective components. The system would further include a compliance database having data related to substance compliance criteria of individual components, the compliance database, where the compliance database may include a compliance corrective action engine configured to generate corrective action requests when a component is determined to not be compliant, and a validity engine configured to determine whether the predetermined substance compliance criteria have been met, and also configured to calculate a best case amount of a substance and a worst case amount of a substance contained in a product for comparison with the compliance threshold, and is further configured to cause the compliance corrective action engine to generate a request for a compliance corrective action if the amount of the substance contained in the product is above a predetermined threshold.

Gathering Material Data:

The invention is intended to facilitate compliance with government laws and regulations, and thus many of the fundamental facts that the invention uses are based on statements from responsible individuals who are in a position to know the underlying facts.

These statements often carry some legal weight. Typically the user of the invention is not expected to actually perform analytical chemistry on the various parts that make up his or her company's products. Rather, the user (typically the compliance manager) is expected to gather written statements, which may be contractual or legally binding statements, and which usually will be in electronic form, from the various suppliers pertaining to their respective parts or components. These statements, which may be based on experimental testing by the supplier, or may be based on other means, are assumed to be true. In the event that they are not true, as long as the compliance manager has done an adequate due diligence to ensure that the statements were obtained from responsible personnel at the supplier, than the consequence of misstatements will usually (but not always) fall on the supplier.

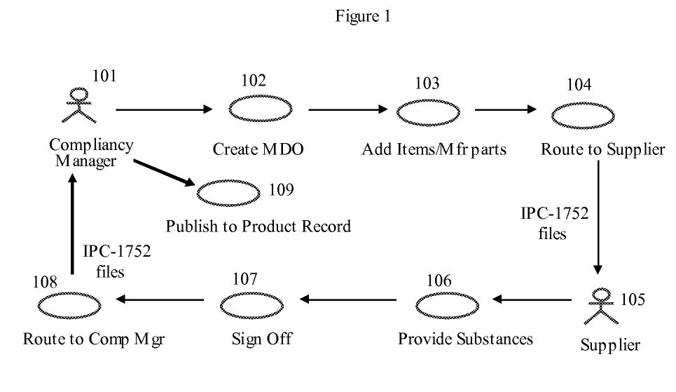

Before the system can begin to assess compliance, data must be entered into the system. This process is shown in FIG. 1. Typically a company assembling a complex product out of component parts and materials will have only limited knowledge of the actual elements and chemicals that make up the parts and materials. By contrast, the suppliers of their respective parts and materials will usually have far more extensive knowledge of this type of chemical composition information, but will not know exactly what products the supplier's parts and materials are b eing used in.

To begin this process, a person, here designated a “compliance manager” (101), will determine what parts and materials are going into a given product, and open up a material declaration file (102) (often called a “material declaration object” or “MDO” in computer terminology).

This declaration file will initially be populated (103) with information available to the compliance manager, often obtained through inspection of literature, email with the vendor, and so on. Although this information can be stored in a wide variety of formats, including paper, spreadsheet files, pdf files, etc., it will often be highly useful to use a standard data interchange format, such as the XLM based IPC-1752 standard, or equivalent. Use of a standardized computer readable format greatly reduces the amount of effort required to keep up with a large number of different parts and materials.

Alternatively a supplier may proactively complete a material declaration file (or MDO) on its parts and materials, preferably in a standardized format such as IPC-1752, and have them available to send to its customers upon request.

Examples of information transmitted by the IPC-1752 format include an RoHS declaration that the item either does not contain RoHS restricted substances, that the item contains RoHS restricted substances and is not under an RoHS exemption, that the item does not contain RoHS restricted substances except for lead in solder (which is exempted for servers and network infrastructure equipment), that item does not contain RoHS restricted substances except for selected exemptions, etc.

The IPC-1752 format also includes the electronic industries alliance Joint Industry Guide (JIG) item level material composition declarations, which list various JIG level A and level B substances that must be declared if they exceed certain JIG defined threshold levels. These threshold levels vary according to the particular substance. As an example, any intentionally added asbestos is non-compliant regardless of the level in PPM. Cadmium has a threshold level of 75 PPM. Arsenic must be declared at thresholds above 1000 PPM, and so on. Further information on the IPC-1752 materials declaration management standard is available from the IPC Association Connecting Electronics Industries IPC 1752 for Materials Declaration published by IPC.

Once the compliance manager has initially completed the MDO file for a part of interest, errors can be prevented by using a “closed loop” system in which the compliance manager sends the MDO file to the supplier to verify accuracy, and also to ensure that the supplier realizes that the data is being used for legal and regulatory purposes (104).

The supplier (105) in turn should verify that the MDO file is accurate, supply any additional missing information (106), such as a list of substances of regulatory interest to the part's or material's MDO. The supplier will also officially sign off on the data (107), which helps insure the legal and regulatory status of the data. The supplier will then return it (108) to the compliancy manager. Once the compliancy manager has verified that the information in a particular MDO is accurate, the information can then be officially added to the system (109) (published to the product record), and the latest information will typically supersede any earlier information. The closed loop process helps insure that the information is of high quality, and also helps ensure that the information is of a high enough quality to have potential legal standing in the event that problems surface at a later date.

Put another way, the Material Declaration Object (MDO) is a software set of linked data (object) that acts as software file record or container for the various parts and substances that go into a product. As previously discussed, it is used as way to exchange data between the compliance engineer and the supplier. The compliance engineer will typically add the parts (item or mfr. part) to the MDO and ask the supplier to provide the material data for these parts. The supplier then adds the materials (or substances) to parts to the MDO, and sends the MDO back to the compliance engineer. The engineer can verify the contents (if necessary) and, if all is in order, will typically then publish (add) the materials to the product records that are electronically contained in the invention's database. Once electronically entered into the database, these materials will be visible to users of the system, typically in a relevant portion of a relevant user interface screen in a user display. Often this information will be reported in an Item-Composition tab or a Mfr. Part-Composition tab. Using this information, the user can then summarize or “rollup” the quantities of all the materials in a given top-level assembly, and find out if the assembly is compliant with a given set of regulations.

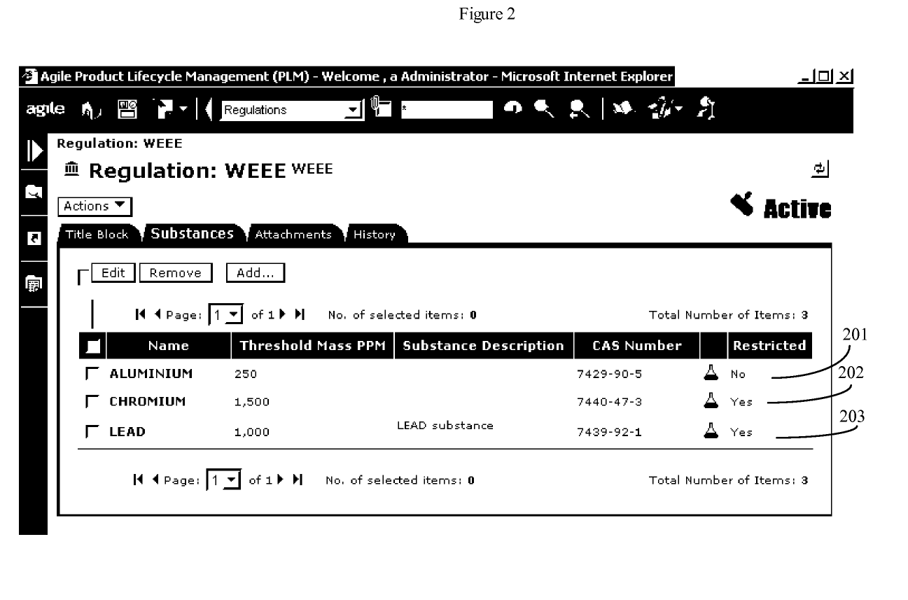

Of course, for the system to know the regulations, these regulations must be first entered into the system as well. An example of regulation data entry is shown in FIG. 2. This figure shows an example regulation threshold limit entry screen taken from the user interface computer screen of the invention. The user interface may optimally be coded in HTML and be displayed in a standard internet web browser on the user's computer, which may be located in whatever location the user finds most convenient.

Here, the system is being informed that according to the ROHS regulations, the amount of aluminum in a part is not restricted (201) but the amount of chromium is restricted, and must have a maximum threshold mass of less than 1,500 parts per million (202). The amount of lead is also restricted, and must have a maximum threshold mass of less than 1,000 parts per million (203).

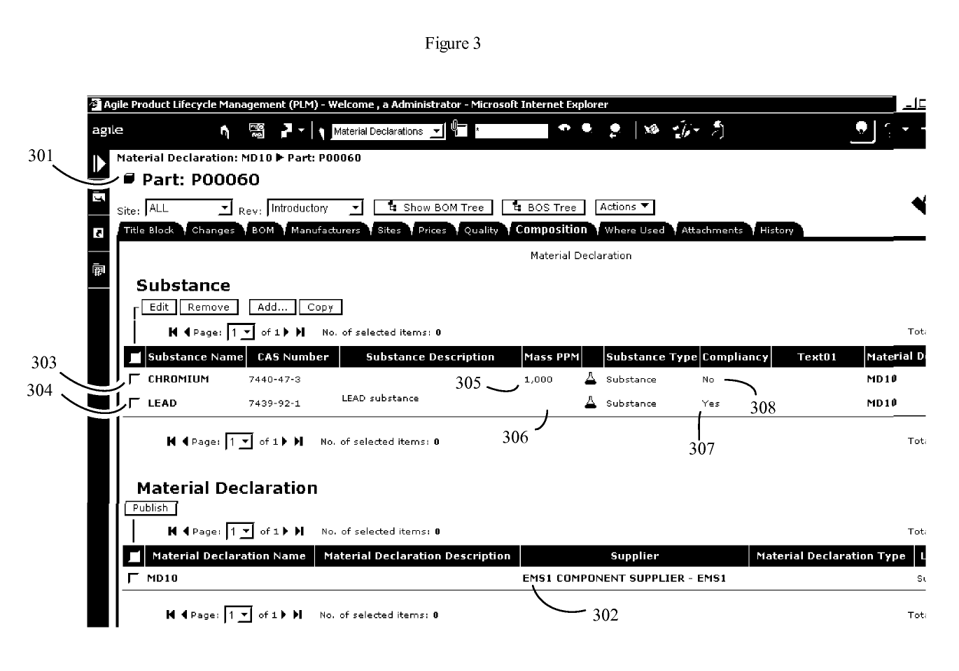

FIG. 3 shows an example material declaration taken from an HTML form located on the web browser on user interface computer, as provided by the invention. This screen shows a manufacturing part P00060 (301). This declaration is taken from the EMSI component supplier (302). As can be seen, the supplier has declared that the part contains two substances of potential regulatory interest, chromium (303) and lead (304). The mass parts per million of the chromium is quite high (1,000 PPM) (305) which exceeds RoHS limits for chromium. By contrast, the mass parts per million of the lead is presumably too low to report (306). As a result, the supplier has only been able to certify that the part is compliant for lead (307). The part is not compliant for chromium (308).

Data Objects

The invention typically will not enter in the material substance data and environmental regulation data on a stand-alone basis, but rather will more typically integrate this data into data structures that incorporate other typical product lifecycle management (PLM) data as well. This other product lifecycle manager data will usually contain at least a bill of materials (BOM) for a given product, which lists the various parts that make up the product. The other product lifecycle manager data will usually also contain supplier information, design information, price information, and so on.

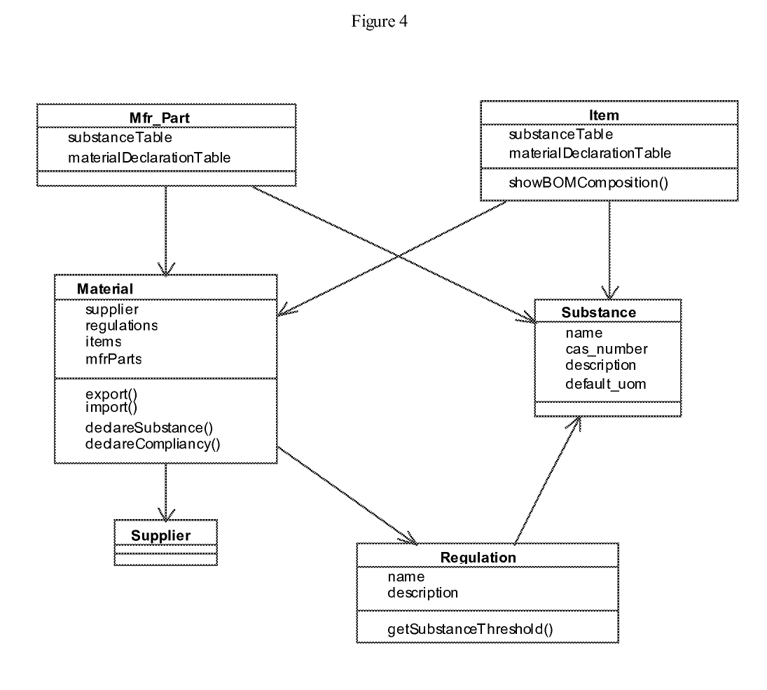

A high level view of how the regulatory data, substance data, material data, manufacturing part data, and item data are linked via software in a way to enable the data to be processed in a product lifecycle manager system is shown in FIG. 4. Here, one way to achieve this linkage is by linking through the bill of materials data. The BOM links to the substance data, supplier declarations, and regulations in a simple manner, and the BOM also links to the other functions and data objects in the main portion of the PLM.

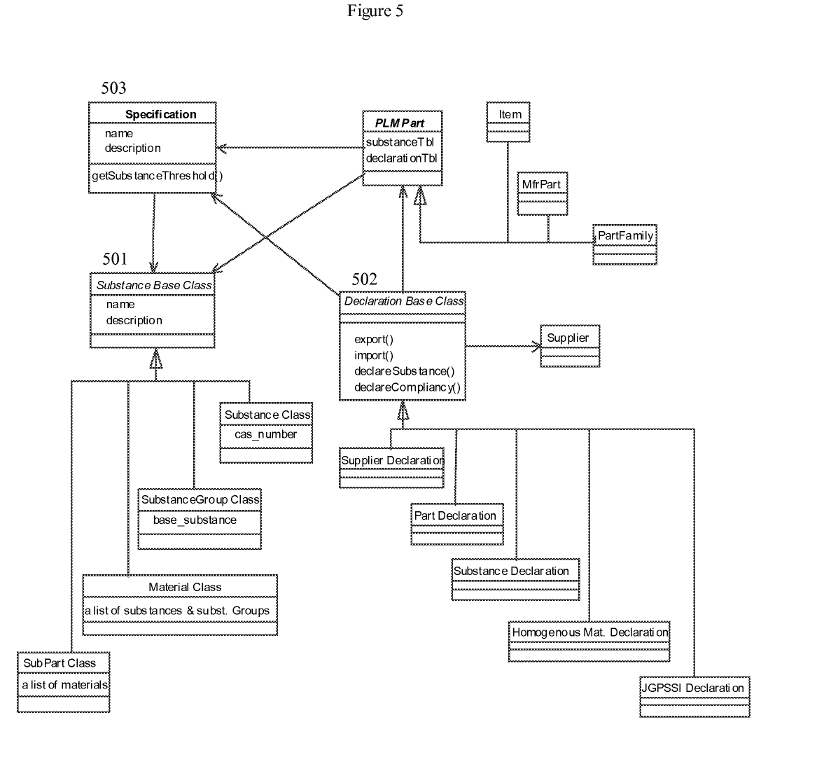

A more detailed diagram of one possible data structure suitable for the invention is shown in FIG. 5. Here the material composition data (material declaration data) the substance data and the regulatory data is stored as three high level “base” classes, which are linked to each other and the bill of material (BOM) and supplier data by software links. The three high level base classes are the substance base class (501), the declaration base class (502), and the specification base class (503). The names of some of the main database subroutines and functions that operate on this data, such as export( ), import( ) etc. are shown inside the various boxes. In most cases, the functions that are performed by these various subroutines should be self-explanatory.

The substance base class (501) stores the chemical information related to the actual parts, subparts, materials, substance groups and substances in the various parts being tracked by the manufacturer are stored. This is generally arranged in a hierarchy as follows:

```
I: Part
    A: Subpart
        1. Material
            a. Substance Group
                i. Substance
```

This section contains basic chemical data for the substances including the specific CAS number if available, a list of various base substances (lead) contained in the item, the list of substances and substance groups contained in the item (e.g. lead acetate), and finally the specific list of materials contained in the part.

The declaration base class (502) stores much of the legal and paperwork data associated with the supplier material declaration data previously obtained in FIG. 1. This data structure includes a record of the top level supplier declaration of conformance for an item, and supplier declarations for various parts and substances contained in the item are also contained here. The Japanese government environmental regulations are somewhat different from the European and American government regulations, in that the Japanese Green Procurement Declaration (JGPSSI declaration) only allows substance groups for parts. Thus the JGPSSI data is treated separately in its own category.

The declaration base class is also where the basic paperwork that verifies that the various parts, subparts, materials, substance groups, and substances that are stored in the substance base class actually complies (or does not comply) with various environmental standards.

The specification base class (503) contains a list of substances of regulatory interest and their allowed thresholds. Each substance of regulatory interest can be flagged as “mandatory” or “optional”. If it is mandatory, it will be used in the compliance validation calculations and rollups. If optional, it will be ignored.

All data types are associated with each other and with the manufacturing parts in the bill of materials that is stored in the main portion of the product lifecycle manager. This way the linkages between the data can be examined as needed by various analysis subroutines and API.

Rollup Data Analysis

The invention can traverse the various data structures shown in FIGS. 4 and 5, and analyze and summarize the data according to various types of regulatory compliance rules, such as RoHS compliance (ROHS Rollup), WEEE compliance (WEEE Rollup, etc.). In general, the system operates on the data according to the following rules:

Part level validation: Certain regulations or specifications require a part to be compliant as a whole, as far as substances are concerned, while other regulations require sub-components of apart to be compliant in order for the part itself to be compliant with regulations. If the subcomponents in apart aren't known, but the elements and chemicals in the part as a whole are known, then the part can be validated at this level, but typically not for compliance at the sub-component level.

Homogenous material level validation: Parts can be validated by determining if the substances contained in each sub-component are compliant with regulations. Since a part is simply the sum of its sub-components, then if the substances in all the subcomponents are acceptable from the regulatory standpoint, then the overall part is considered to be validated. Parts that are declared at a homogenous material level can be used for validation at a part level. The reverse however is usually not true. Parts declared at the part level should not usually be validated at the homogenous material level.

Validate for every specification: Often there are multiple environmental regulations and specifications acting at once. For example, there may be one specification for lead, and a different specification for cadmium. The invention will generally perform a separate analysis for each different specification. Thus, for example, a nickel cadmium battery might pass a lead specification but fail a cadmium specification.

Rollup (Data Analysis) Algorithms:

It is often the case that the material declarations of various parts from various suppliers are not totally complete or consistent. Some suppliers simply declare a part to be compliant to various regulations without giving more specific chemical composition data. Other suppliers provide chemical composition data without declaring compliance, and leave it to the compliance manager to make a compliance determination. Still other suppliers provide both sets of data. Some suppliers simply specify how the device is to be recycled or reused, which itself inherently contains some substance information because parts with that contain environmentally regulated substances have more stringent reuse criteria than parts that do not contain environmentally regulated substances. As a result, to produce a robust system that is capable of functioning adequately in the real world, it is important to have many alternate ways of calculating compliance. This way, the limited available data can be used as efficiently as possible.

Before proceeding with a detailed review of the various computer algorithms behind the compliance calculations performed by the invention, two specific examples will be discussed in detail.

These two examples are based upon two alternative ways of analyzing the compliance of a higher level (more complex) item in terms of its basic composition. The first way is to analyze the compliance of an item by summing up the various elements and chemicals in the item (analyzing the item's bill of substances). This way is most appropriate when the supplier has presented detailed chemical information. The second way is by summing up the compliance (or lack thereof) of the various parts that make up an item (analyzing the item's bill of materials, which summarizes all the different parts and components that make up an item). This way is most appropriate when the supplier(s) has verified compliance, but may not have given detailed chemical composition data.

### EXAMPLE 1

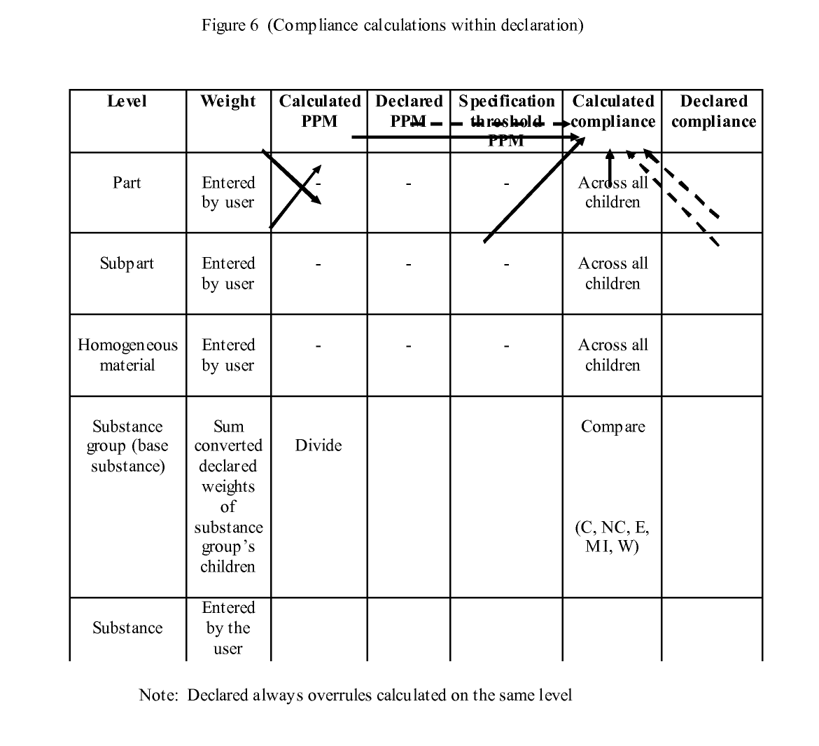

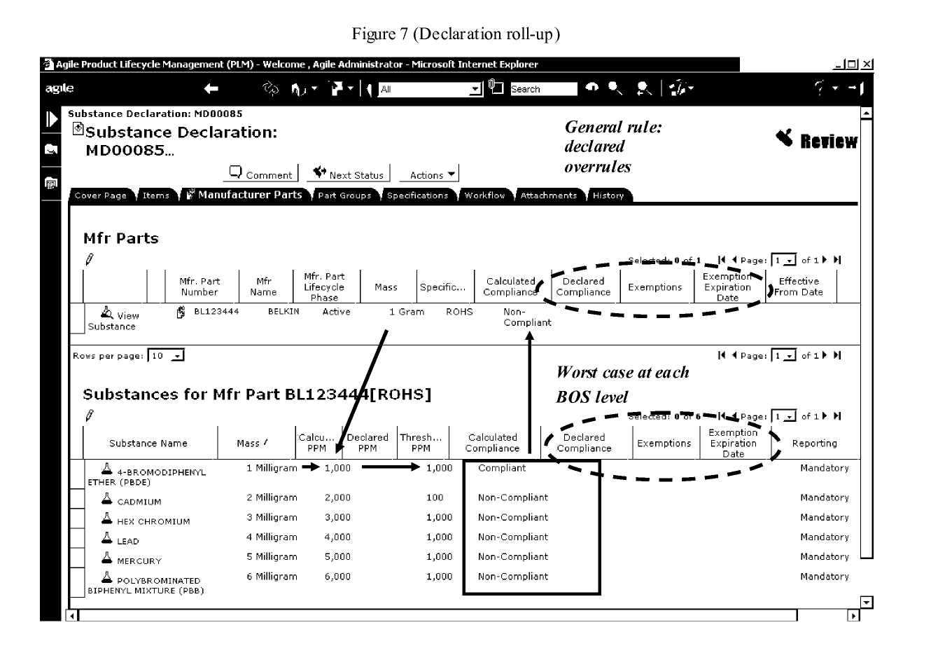

One way to calculate compliance is by traversing the bill of substances (BOS) from the bottom to the top. This way is shown in FIG. 6. The method essentially examines the bill of substances of each part of the declaration, and calculates parts per million (PPM) of the various substances, and matches this with the allowed regulatory specification parts per million, and determines if the item is compliant. If, at any point, there is a discrepancy between the calculated amounts of the regulated substance in terms of PPM, the declared PPM (which presumably comes from a supplier with greater knowledge of the part) will be used. An example of the user interface presented during this type of analysis is shown in FIG. 7.

### EXAMPLE 2

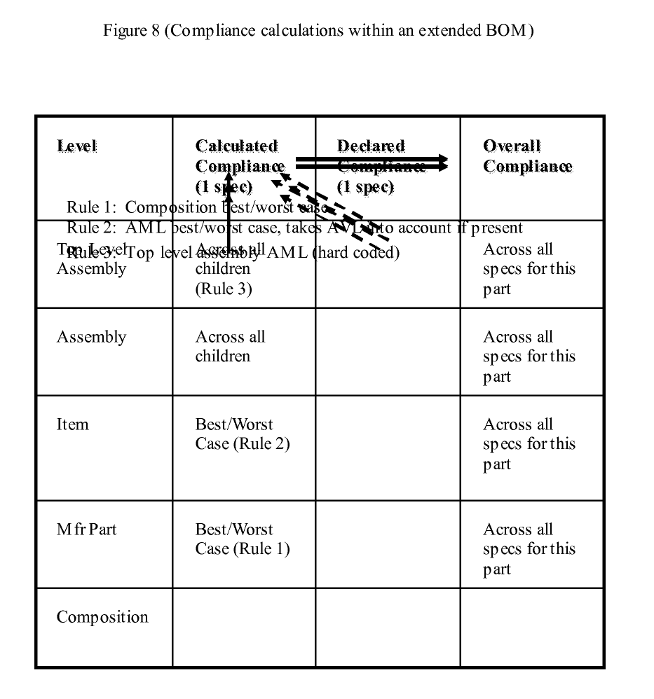

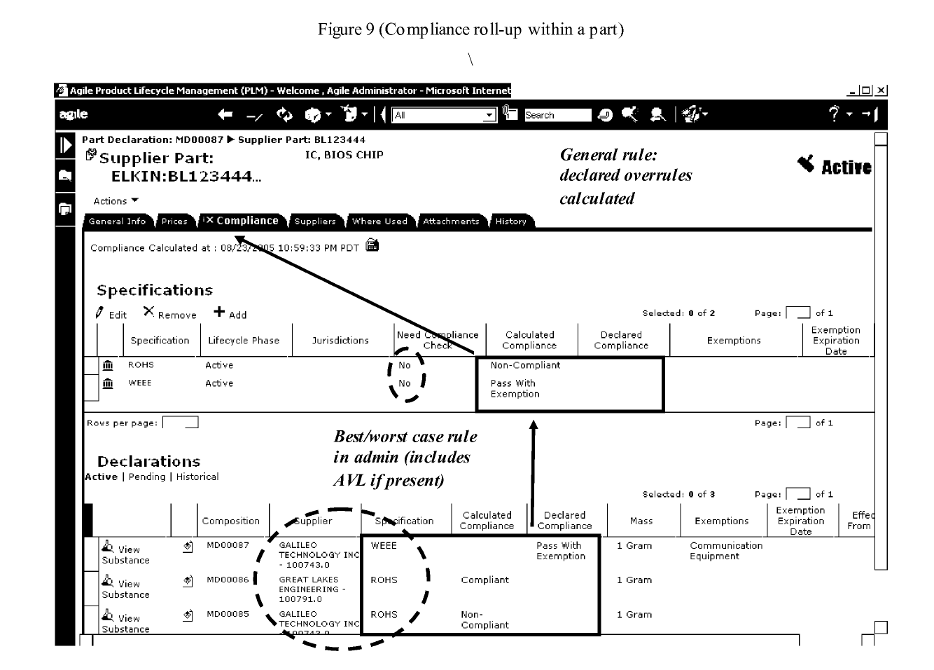

A second way to calculate compliance is by traversing the bill of materials for an item from the bottom smallest or simplest subunits to the top (highest level assembly). This way is shown in FIG. 8. Here the bill of materials data has been extended to additionally contain the environmental regulatory compliance data collected in FIG. 1. The logic behind this type of compliance calculation is that that if one of the part's subcomponents (children) is not compliant, the part itself is considered to be not compliant. However if all of the top level parts sub components are compliant, then the part must be compliant. An example of the user interface presented during this second type of analysis is shown in FIG. 9.

In addition to analyzing bills of materials, the method of example 2 can also be used to check if a part on an approved materials list (AML) is compliant. Here the invention may use either a pessimistic worst-case or an optimistic best-case setting. In the pessimistic worst-case setting, the invention will determine that the item is compliant only if all of its manufacturer's parts are compliant. If one of the manufacturer parts is not compliant, then the item will be deemed to be not compliant.

Alternatively, in the optimistic best-case setting the item will be deemed not compliant only if all its mfr parts are not compliant. This is usually unrealistic, however, and as a result, the pessimistic worst-case parameters are generally preferred. This mode may be used to determine if there is a combination of parts that would allow the manufacturer to build a compliant product out of all possible combinations.

If a component or subcomponent has a blank substance field, then the invention will generally ignore this part and continue analyzing the other parts. However at the completion of the analysis, the invention may then do the following: If the preliminary analysis (rolled-up) result indicates the top-level item is otherwise compliant, then we may still flag the final result as unknown, since we don't know if the part with missing data is compliant or not. However if the top-level item is not compliant, this result will be kept unchanged (i.e. remain non-compliant).

Data analysis (rollups) can be done on substance lists, compositions, declarations, components, approved manufacturers lists (AML), and the bill of materials (BOM).

Exemptions: In certain cases, certain exemptions are allowed to the rules set by regulations, customers, or management. These exemptions extend the compliant and non-compliant flags to: compliant, pass with exemption, waiver in place, unknown (missing information in PG&C), and non-compliant. Typically “waiver in place” is a temporary exemption granted by management.

The “pass with exemption” flag is particularly useful. Many regulations recognize the difficulty in rapidly converting to environmentally acceptable materials, and exempt certain types of products, such as internet servers and medical equipment, or substances in components (e.g. mercury in energy saving light bulbs), from such environmental regulations. Thus it is important that the PG&C system be able to recognize such exempt items.

Other exemptions include the ability to set a flag to allow the system to pass apart, or a sub-p art, material, substance group and substance with exemptions. If necessary, this can be a multi-list exemption field where the user can select which regulations the item is exempt from, and which regulations the item is not exempt from. If this option is chosen, then this exemption list will usually be revealed when the part is inspected. As another type of exemption, users can declare that the compliance status is: “waiver in place” to indicate that the part is temporarily allowed (exempt) so that the product design process is not held up.

Substance Composition:

As previously discussed, suppliers usually provide documentation with each subpart, materials, substance group, or substance. This documentation lists the properties of the part, and includes a discussion of any substances of regulatory interest that the item may contain, often with some sort of certification that the item does or does not comply with various regulatory standards. Often there may be multiple sets of this type of documentation, because the same item may be obtained from more than one supplier, each of whom may provide a slightly different item or a slightly different set of documentation. This information is normally entered into the data structures of the invention, either by directly importing the data from the supplier or by manual entry by the user. This set of documentation will often be termed a “substance composition”.

Environmental standards are new, and many suppliers are still grappling with these regulations. As a result, supplier documentation will often be deficient in providing information that is needed to comply with rapidly evolving regulations. In some cases, a supplier may simply give the item's overall element and chemical makeup as a “parts per million” (PPM) declaration, but not declare if the item is in compliance with a particular set of regulations. In this case, the composition documentation is the to be an “all specs” composition.

For any given part, there should be at most one relevant “active” set of composition documentation per supplier and per specification. The relevant “active” set of composition documentation is usually the latest set of data that has been imported. If there was a previous set of composition documentation, it will usually be stored and set to “inactive” status.

Substance Lists Compliance Analysis:

As previously discussed, the entire compliance analysis can be based on the list of substances. During the analysis of the substance data for each part in a given product, each of the component's substances are checked to see if it they are compliant. If all of the products various components are compliant, then the product is compliant. If one of the product's components contains a substance that is not compliant, then the product as a whole is deemed to be noncompliant.

If the substance list contains a substance that doesn't exist in the corresponding spec, then this substance will be ignored, and thus it is not counted for the final compliance.

If the regulatory specifications contain a substance that doesn't have a minimum threshold of acceptability, then the compliance of this particular item is determined by the item's declared compliance flag, which is often certified by the item's particular vendor. If this compliance flag doesn't exist (most likely because the item's vendor did not certify the item for this regulatory issue), then the compliance of the item and the product will be set to ‘Unknown’.

If a member of a substance group is present (for example, the item lists a certain level of a compound such as lead acetate), then the compound (e.g. lead acetate) will be converted (using a conversion factor) into the substance group's base substance (lead). And the compliance validation will be based on this base substance. Thus if the item contains so much lead acetate as to exceed the regulatory limit on lead, then the item will be determined to be non-compliant based on the calculated amount of lead in the lead acetate, using the mass of the lead acetate in the item and an appropriate conversion factor.

Part Level Validation

Alternatively, as previously discussed, the invention can validate a product at the part level. When this type of analysis is done, the invention does not check the compliance of each part's subcomponents or materials. Rather, the substances of regulatory interest from all of the items materials and sub-p arts are added together, and the overall compliance of the item is then based on the compliance (or lack thereof) of the items various constituent substances of regulatory interest. Often the invention will calculate based on the following rules:

If the user declares that the parts per million (PPM) of substances of regulatory interest in the parts, then he/she should also input (declare) the mass of the particular part. The software will then use the two sets of data (parts per million, mass) to calculate the actual mass of the substance of regulatory interest in the part, using the equation:

Mass of Substance=Mass of Material*(Substance PPM/1,000000)

The ‘Mass of Material’ is the material weight given by a user when adding the material to the part. The ‘Substance PPM’ is the PPM of the substance within the material. It can be either given by a user, or calculated from the substance mass and the material mass. This PPM determines the percentage of the substance contained in the parent material.

As an example, we have the following Material object:

Alloy

| | |
|---|---|
| \|---- Lead | 500,000 PPM (i.e. 50%) |
| \|---- Cadmium | 100,000 PPM (i.e. 10%) |

And we declare the following substances/material for the part P00001. Lead and Iron are direct substances.

P00001

| | |
|---|---|
| \|---- Alloy | 20 g (i.e. gram) |
| \|---- Lead | 5 g |
| \|---- Iron | 6 g |

As a result, the rollup analysis for P00001 will be:

P00001

| | |
|---|---|
| \|---- Lead | 15 g (i.e. 20 g * 50% + 5 g) |
| \|---- Cadmium | 2 g (i.e. 20 g * 10%) |
| \|---- Iron | 6 g |

The compliance of P0001 will be determined by the compliance of its substance list (lead, cadmium, and iron).

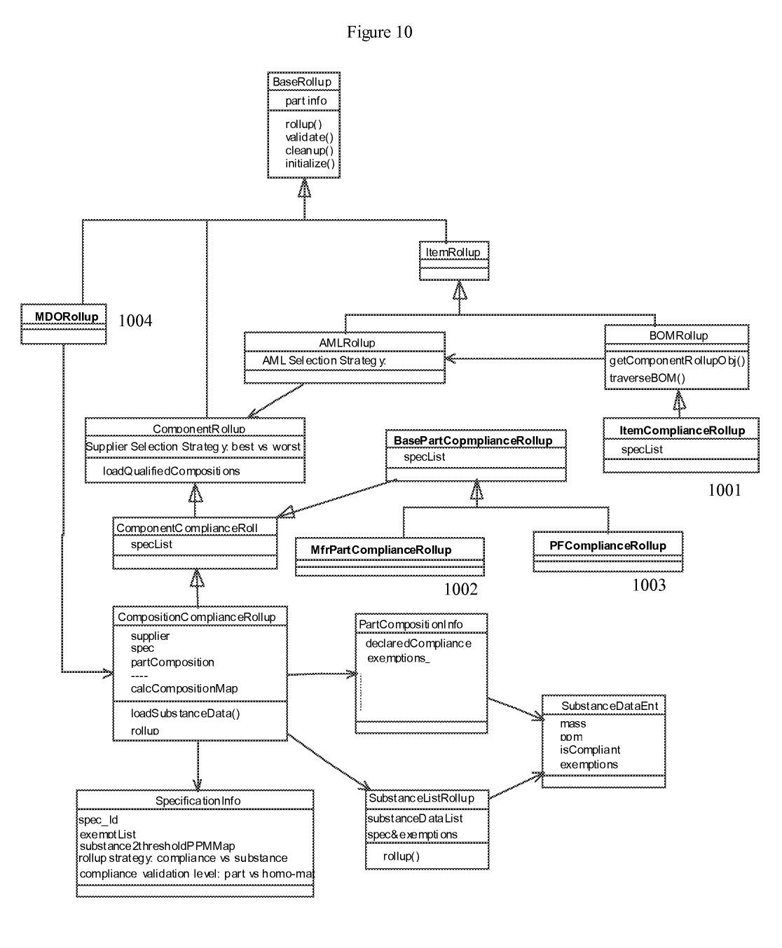

As previously discussed, the invention uses a variety of different algorithms to analyze compliance. FIG. 10 gives a high level overview of some of these various “rollup” algorithms, and also shows how they relate to each other. Examples of some of these application program interfaces are ItemComplianceRollup (1001), MrfPartComplianceRollup (1002), PFComplianceRollup (1003), and MDORollup (1004). These API may be reusable software components coded as encapsulated objects in the Java language (JavaBeans).

The ItemComplianceRollup (1001) applications program interface (API) traverses (analyzes) the bill of materials (BOM) and calculates the compliance of each part based upon the compliance of the part's subcomponents (children). It also records a record of when the last analysis was done.

The MftPartComplianceRollup (1002) analyzes the specifications associated with each manufacturer part.

The PFComplianceRollup (1003) is short for Part-Family Compliance Rollup.

The MDORollup (1004) checks the material declaration information (material declaration object) for compliance. This algorithm also checks to see if there were changes in the material declarations since the last analysis.

A number of the other API's and functions performed during the overall compliance analysis are also shown in FIG. 10, most of which have self explanatory names.

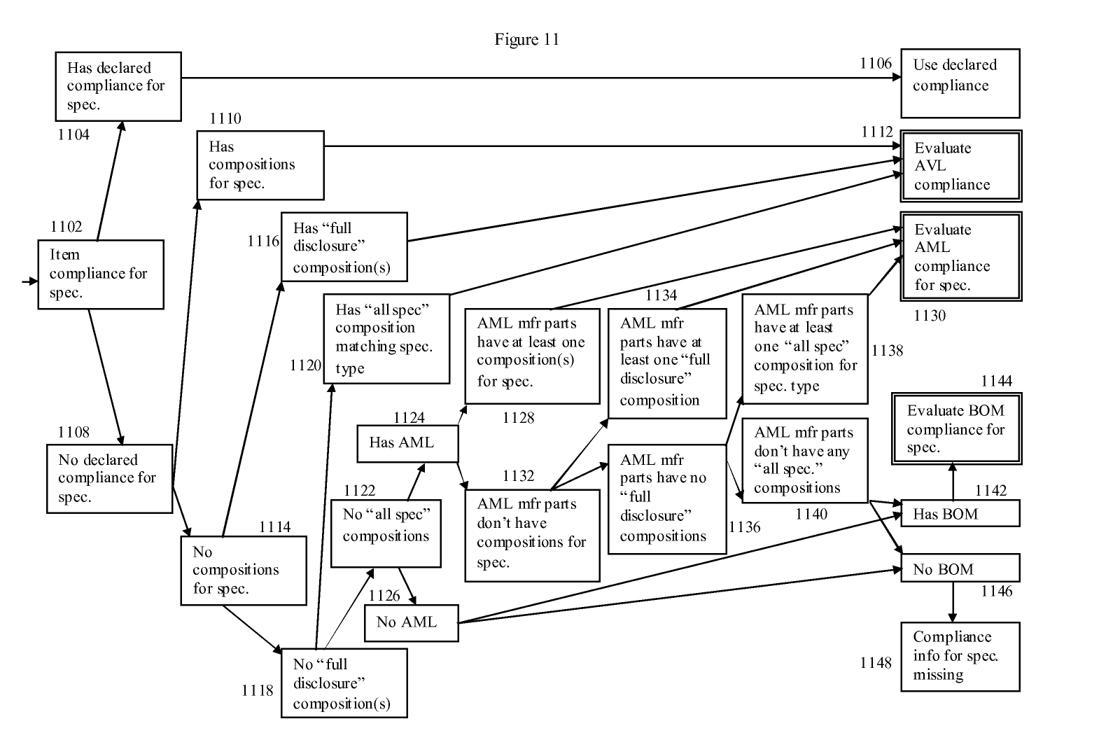

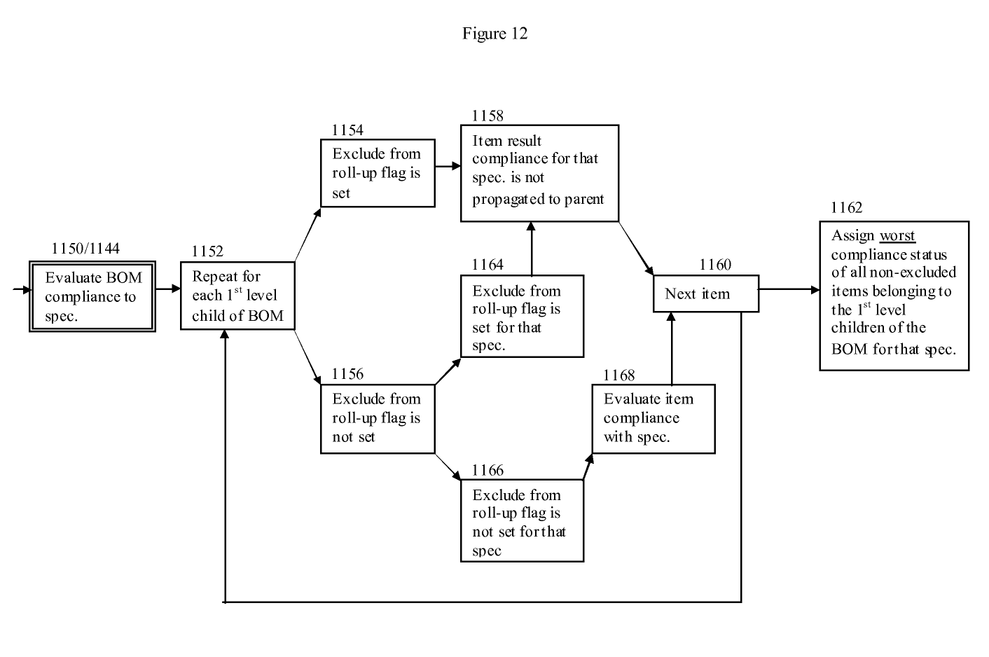

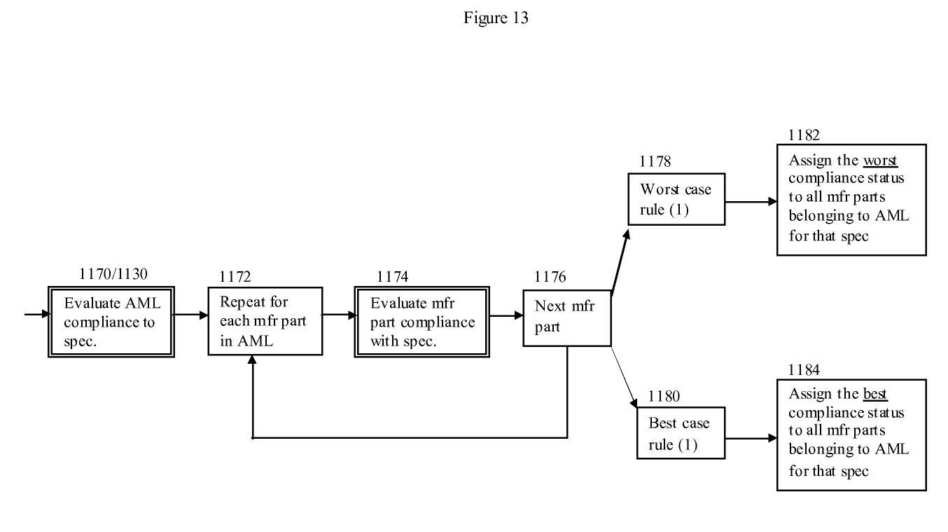

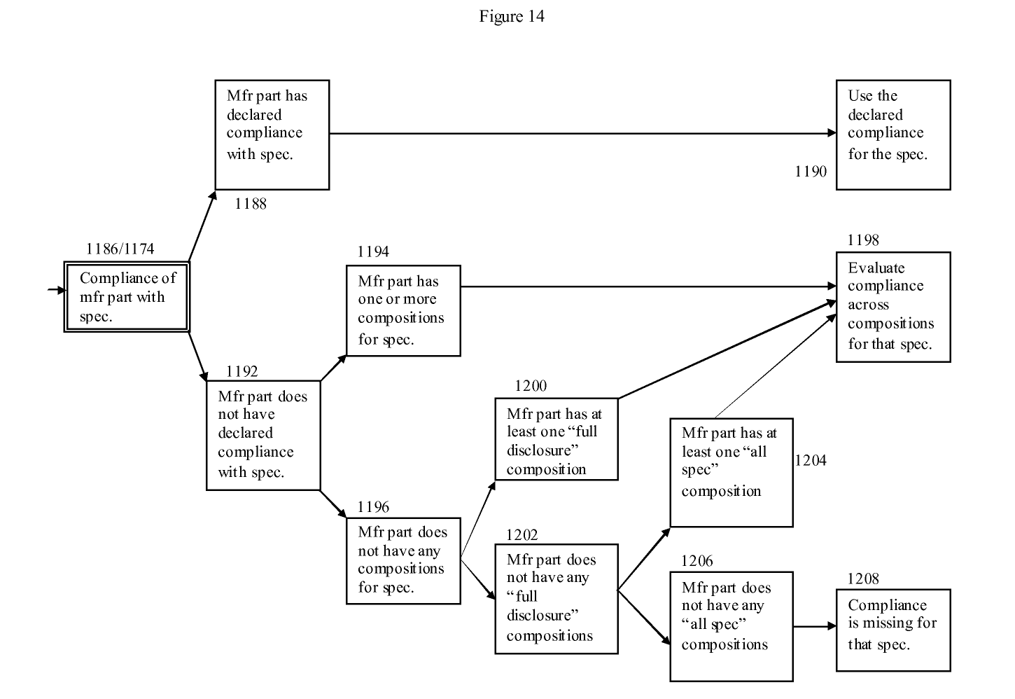

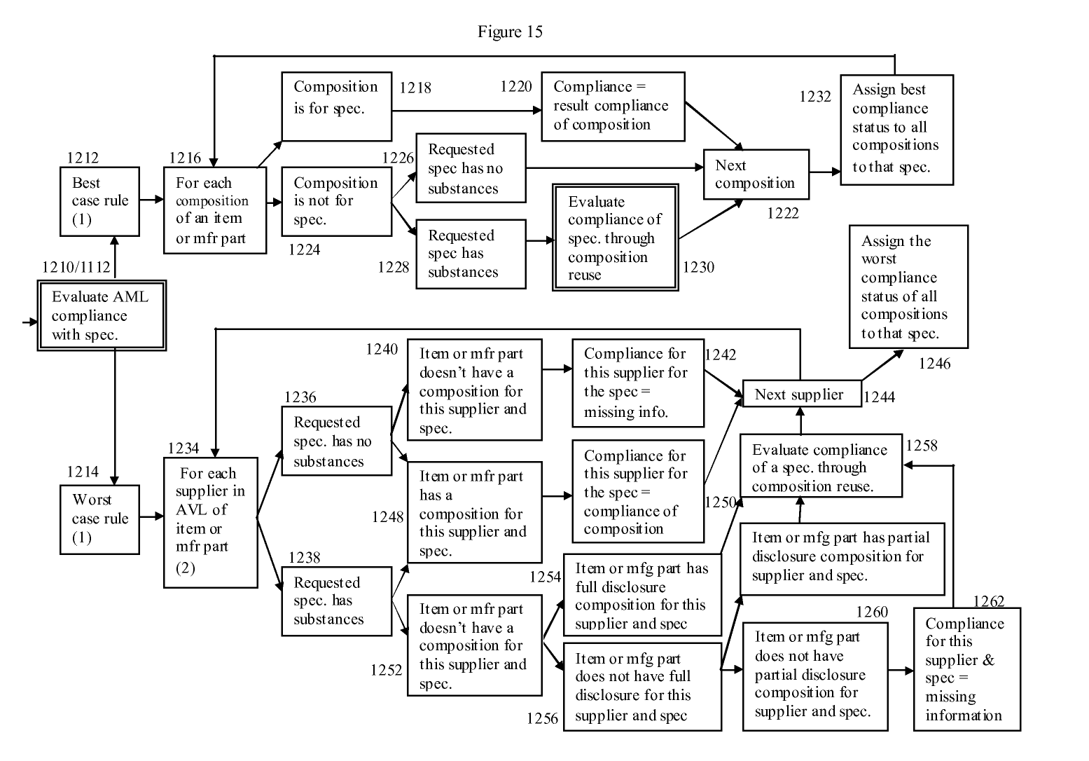

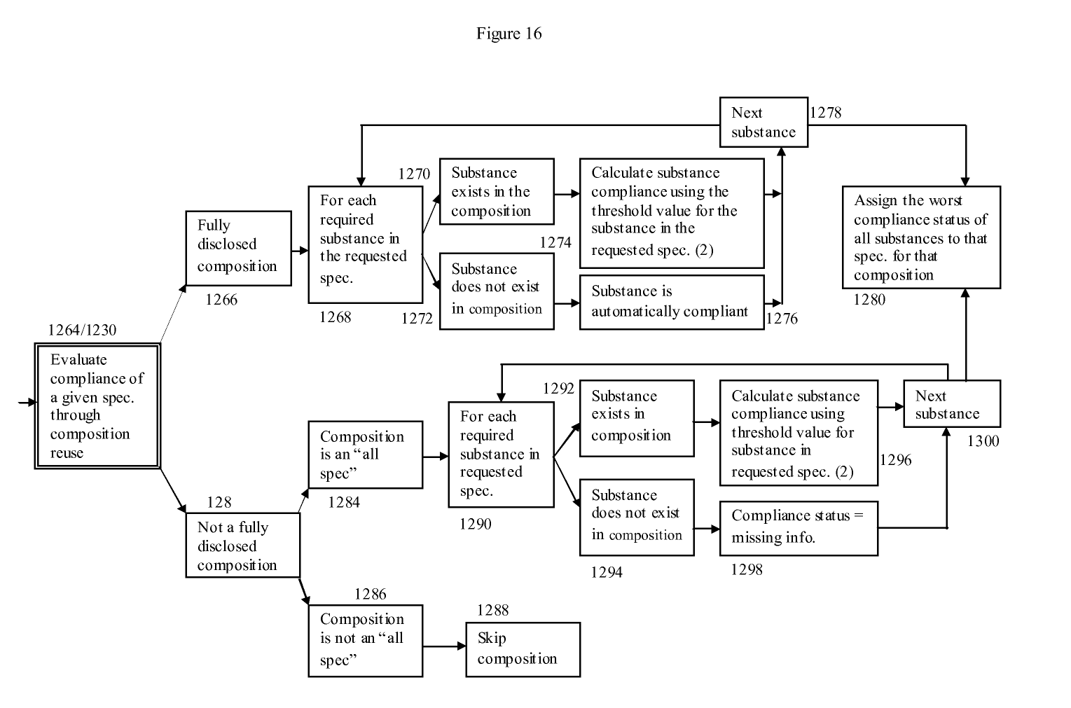

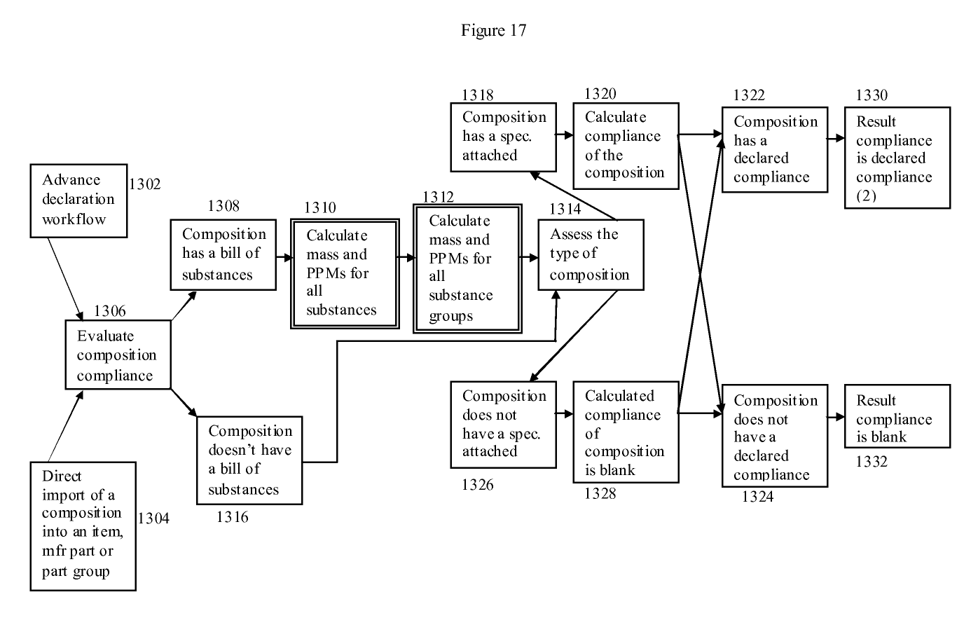

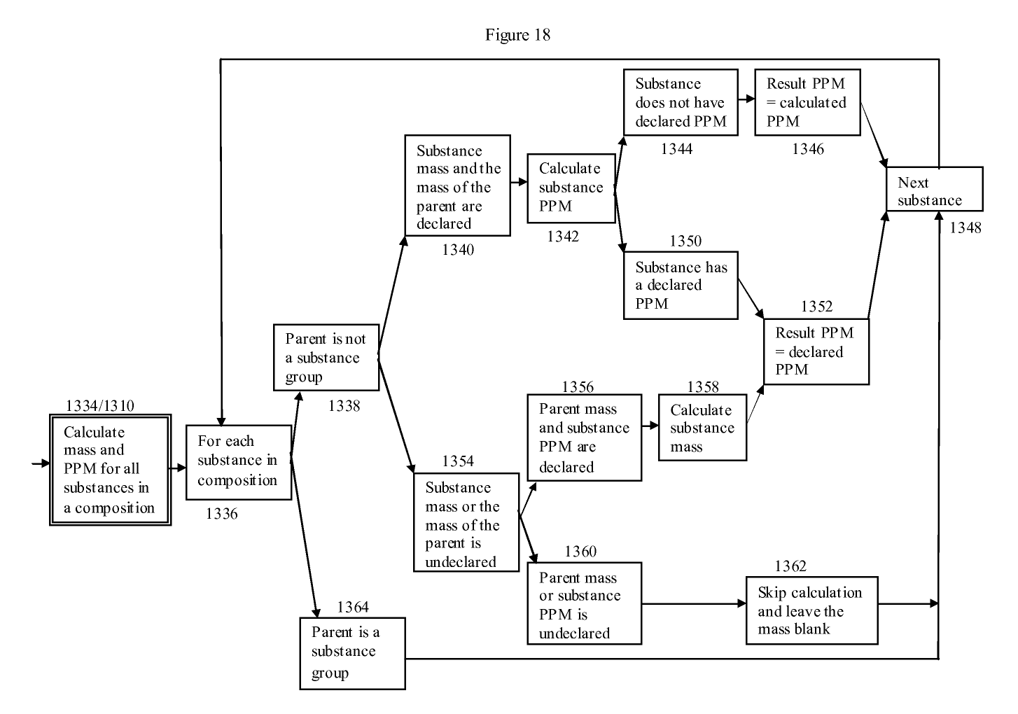

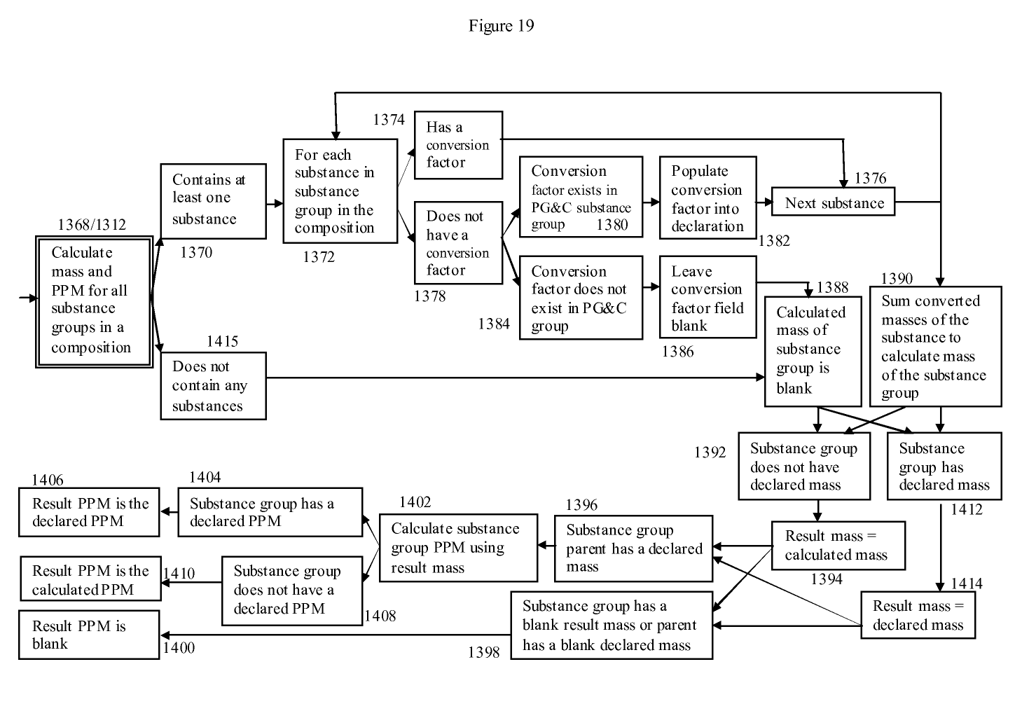

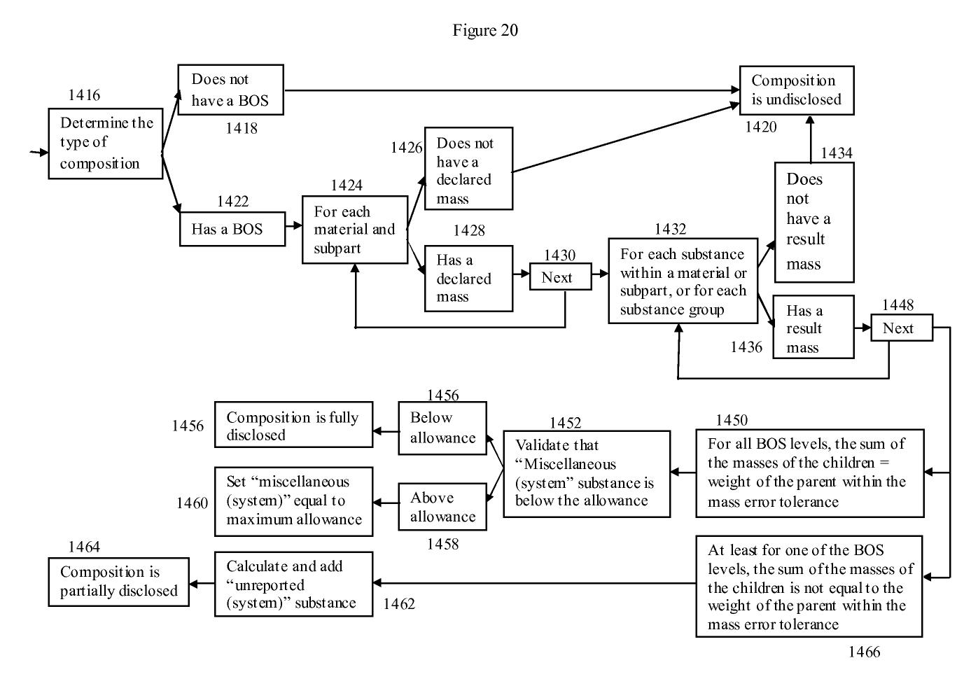

Further examples of these various types of algorithms are discussed below. These examples include item compliance of the assembly or component (FIG. 11), Bill of Material (BOM) compliance (FIG. 12), Approved Manufacturer's List (AML) compliance (FIG. 13), Manufacturer part compliance (FIG. 14), Approved Vendor List (AVL) compliance (FIG. 15), compliance calculation through reuse (FIG. 16), composition compliance (FIG. 17), calculating the mass and parts per million (PPM) of substances of regulatory interest (FIG. 18), calculating the mass and PPM of substance groups of regulatory interest (FIG. 19), and assessing the composition type (FIG. 20).

Referring first to FIG. 11, the process begins in step (1102) where compliance of an item with given specification is illustrated. First, it is determined whether an item has a declared compliance for that specification in step (1104) or whether the item does not have a declared compliance for that specification in step (1108). If the item has a declared compliance for that specification, the process goes to step (1106) where the compliance is the declared compliance for that specification. The process ends here if that is the case. However, if it is determined in step (1108) that the item does not have a declared compliance for that specification, the process proceeds to step (1110) where it is determined whether the item has one or more compositions for that specification. If it does, the process proceeds to step (1112) where the process evaluates the AVL compliance for that specification. If, however, the item does not have any compositions for that specification as determined in step (1114), then it is determined whether or not information can be reused. In step (1116), is determined whether the item has at least one full disclosure composition. If it does, than the process proceeds to step (1112), where the process evaluates the AVL compliance for that specification. If however, it is determined in step (1118) that the item does not have any full disclosure compositions, than the process determines first whether the item has at least one “all spec” composition of the same type as specification. (An “all spec” composition is a composition without a regulatory specification attached, e.g. declaring PPM for a substance without a statement if the PPM complies with a regulation, which has some advantages in that it can be used to assess compliance with a new regulation)

If it does, than the process proceeds to step (1112) where the process evaluates the AVL compliance for that specification. If however, it is determined that the item does not have any “all spec”, in step (1122), than it is determined whether or not the item has an AML. If it is determined in step (1124) that the item have an AML, than the process proceeds to step (1128) to determine whether AML manufacturer parts have one or more compositions for that specification. If this is the case, then the process proceeds to step (1130) where the process evaluates AML compliance for that specification. If however, it is determined in step (1132) that AML manufacturer parts do not have any composition for that specification, than the process first proceeds to step (1134) where it is determined whether the AML manufacturer parts have at least one full disclosure composition. If it does, than the process proceeds to step (1130) where the process evaluates AML compliance for that specification. If however, it is determined that AML manufacturer parts did not have any “full disclosure” compositions in step (1136), than the process proceeds to step (1138) where it is determined whether AML manufacturer parts have at least one “all spec” composition of the same type as the specification. If this is the case, than the process proceeds to step (1130) where the AML is evaluated for compliance for that specification. If, however, it is determined in step (1140) that all manufacturers of p arts do not have any “all spec” compositions, than the process proceeds to two steps, first, in step (1142), it is determined whether the item has a BOM. If so, than in step (1144) the process evaluates BOM compliance for that specification. Also, the process proceeds from step (1140) to step (1146) where it is determined whether the item does not have a BOM. If it does not, than the process proceeds to step (1148), where it is determined whether compliance is missing information for that specification.

Referring back to step (1126), if, after step (1122), it is determined that the item does not have an AML, than the process proceeds to two steps, step (1142) to determine whether the item has a BOM, and then to step (1144) to evaluate the BOM compliance for that specification if the item does have a BOM. Also the process proceeds from step (1126) to (1146), where it is determined whether the item does not have a BOM. If it does not have a BOM, than the process proceeds to step (1148) where compliance is missing information for that specification as determined. Thus, after step (1122), it is determined first whether the item has an AML, and the process than proceeds to the determination related to the AML evaluation. If, however, after step (1122) it is determined that the item does not have an AML, these processes for the AML are bypassed, and the process proceeds directly to step (1142) and (1146).

Referring to FIG. 12, a more detailed flowchart of step (1144), evaluating BOM compliance within a given specification, is illustrated. The first step, step (1150/1144), the process is initiated to evaluate the BOM compliance with a given specification. From there, in step (1152), the process evaluates the BOM compliance for each item belonging to the first level of children of the BOM. From there, in step (1154), it is determined whether the exclude from roll up flag is set. In step (1156), it is determined whether they exclude from roll up flag is not set. If the roll up flag is set as determined in step (1154), than the process proceeds to step (1158) where the item result compliance for that specification is not propagated to the parent. Then, in step (1160), the next item is retrieves. The process than proceeds to step (1152) where the process is continued for each item. If the exclude from roll up flag is not set, than process proceeds to step (1164) where it is determined whether the exclude from roll up flag is set for that specification. If so, than the process proceeds to step (1158) where it is determined that the item result compliance for that specification is not prorogated to the parent. The next item is than retrieved from step (1160). With, however, the exclude from roll up flag is not set for that specification as determined in step (1166), and the process proceeds to step (1168) where the process evaluates the item compliance with the specification. The process than proceeds to step (1160) where the next item is chosen. When no further item exists, the process proceeds from step (1160) to step (1162) where the worst compliance status of all non excluded item belonging to the first level of children of the BOM for that specification is assigned.

Referring to FIG. 13, the process for evaluating the AML compliance with a given specification, step (1130) of FIG. 11, is shown in more detail. In the beginning step, step (1170), the process for evaluating the AML compliance with a given specification is initiated. In step (1172), each manufacturer part belonging to the AML is evaluated by the process. After the first manufacturer part information is retrieved, the process proceeds to step (1174) where the process evaluates the manufacturer part compliance with that specification. This step is illustrated and discussed below in more detail in connection with FIG. 14. After step (1174), the next manufacturer part is retrieved and the process proceeds back to step (1172) for further evaluation. After each manufactured part is evaluated, the process proceeds from step (1176) to step (1178) where the worst case rule is established, and in step (1180), the best case rule is established. Each of these rules is established by the AML roll up rule in the administration of the system. After step (1178), the process assigns the worst compliance status of all manufactured parts belonging to the AML for that specification. After step (1180), in step (1184), the process assigns the best compliance status for all manufactured parts belonging to the AML for that specification. Thus, the process of FIG. 13 illustrates the process of establishing the best case rule and worst case rule for compliance of an AML within a given specification.

Referring to FIG. 14, the process for evaluating a manufacturer part compliance with a specification is illustrated in more detail. In the first step, step (1186), which is step (1174) of FIG. 13, compliance of a manufacturer part with a given specification is evaluated. First, in step (1188), it is determined whether the manufacturer part has a declared compliance for that specification. If it does, than in step (1190) it is determined that compliance is the declared compliance for that specification. If, however, it is determined in step (1192) that the manufacturer part does not have a declared compliance for that specification, then, in step (1194), it is determined whether the manufacturer part has one or more compositions for that specification. If it does, than the process proceeds to step (1198) where the process evaluates compliance across compositions for that specification. Referring back to step (1192), if it is determined that the manufacturer part does not have any compositions for that specification, than the process first proceeds to step (1200), where it is determined whether the part has at least one “full disclosure” composition. If it does, then the process proceeds to step (1198) where the process evaluates compliance across compositions for that specification. Referring back to step (1196), if it is determined that the manufacturer part does not have any “full disclosure” compositions, than the process proceeds first to step (1204), where it is determined whether the manufacturer part has at least “all spec” composition. If it does, than the process proceeds to step (1198), where the process evaluates compliance across compositions for that specification. Referring back to step (1202), if it is determined that the manufacturer part does not have any “all spec” compositions; then the process proceeds to step (1208) where it is determined that compliance is missing information for that specification.

Referring to FIG. 15, a flowchart illustrating a process of evaluating an AVL compliance with a given specification as illustrated, the same step (1112) of FIG. 11. This is the composition roll-up rule in the PG&C administration module. Note that the AVL may be maintained in the supplier section of the item, or in the manufacturer part section.

The process begins by initiating the evaluation of the AVL compliance with a given specification in step (1210). The process than proceeds to step (1212) where the best case rule is established. Again, this is the composition roll up rule in the administration. In establishing the best case rule, it is done for each composition of an item or manufacturer part of step (1216). First, an item or a manufacturer part is chosen, than the process proceeds to step (1218) where it is determined whether the composition is for the requested specification. If so, it is determined that compliance is equal to the result compliance of the composition in step (1220). The next composition is retrieved in step (1222), where the process returns to step (1216) to retrieve the next item or manufacturer part. Referring back to step (1216), if it is determined that composition is not for the requested specification in step (1224), than the process proceeds to step (1226) to determine whether the requested specification has no substances. If it does not, than the process proceeds to step (1222) where the next composition is retrieved. Referring back to step (1224), if it is determined that the requested specification does have substances in step (1228), then the process evaluates compliance of a specification through composition reuse. After step (1230), the process proceeds to step (1222) where the next composition is retrieved. Once the last composition of the item or manufacturer part is retrieved, the process proceeds to step (1232) where the best compliance status of all compositions to that specification is assigned. Referring back to the beginning, step (1210), the worst case rule is established in step (1214), where the composition is according to the roll up rule in the administration. The worst case rule is established for each supplier of the AVL of the item or manufacturer part instead of (1234), where the AVL is maintained in the suppliers section of the item or manufacturer part. The process proceeds to step (1236), where it is determined whether the requested specification has no substances. If it does not, than the process proceeds to step (1240) where it is determined whether the item or manufacturer part does not have a composition for this particular supplier and the requested specification. Then, in step (1242), the compliance for this particular supplier for the requested specification is equal to the missing info. The next supplier is then retrieved in step (1244). Referring back to step (1236), if it is determined that the item or manufacturer part has a composition for this supplier and the requested specification in step (1248), than the process proceeds to step (1250), where it is determined that the compliance for this supplier for the requested specification is equal to the results compliance of the composition. The next supplier is than retrieved in step (1244), which returns back to step (1234). Referring back to step (1234), if it is determined that the requested specification has substances in step (1238), than the process first proceeds to step (1248) where it is determined whether the item or manufacturer part has a composition for this supplier and their requested specification. If it does, then, in step (1250), compliance for this particular supplier for the requested specification is set equal to the result compliance of the composition. The process then proceeds to step (1244) for the next supplier. Back to step (1238), if it determined in step (1252) that the item or manufacturer part does not have a composition for this supplier and the requested specification, than the process proceeds to step (1254) where it is determined that the item or manufacturer part has a full disclosure for this supplier and a type of specification requested. The process than proceeds to step (1258) where compliance of a specification through composition reuse is evaluated. The process proceeds to step (1244) for the next supplier. Referring back to step (1252), if it determined that the item or manufacturer p art does not have a full disclosure for this supplier and the type of specification requested in step (1256), than the process proceeds to step (1254) to determine whether the item or manufacturer part has a partial disclosure composition for this supplier and a type of specification requested. If so, than the process proceeds to step (1258) where the compliance of the specification through composition reuse is evaluated. The process than proceeds to step (1244) for the next supplier. Referring back to step (1256), if it is determined, the item or manufacturer part does not have a partial disclosure composition for this supplier and the type of specification requested, the process proceeds to step (1262) where the compliance for this supplier for the requested specification is set equal to the missing information. The process proceeds to step (1258) where compliance of specification through composition reuse is evaluated, and then to step (1244) for the supplier. Once it is determined that no further suppliers exist in step (1244), the process proceeds to step (1246) where the process assigns the worst compliance status of all compositions to that specification.

Referring to FIG. 16, the compliance calculation 3 reuse is evaluated; specifically step (1230) of FIG. 15. In the first step, step (1264/1230), the compliance of a given specification through composition reuse is evaluated. In step (1266), it is determined whether there is a fully disclosed composition. If so, than the process proceeds to step (1268) where each required substance and the requested specification is evaluated. In step (1270), it is determined whether the substance exists in the composition. If so, than the process calculates substance compliance using a threshold value for the substance and the requested specification in step (1274). If this calculation is not possible, than missing information status is assigned. The process than proceeds to step (1278) where the next substance is retrieved in step (1268). Referring back to step (1268), if it is determined in step (1272) that the substance does not exist in the composition, than the substance is automatically compliant, as determined in step (1276). The process then proceeds to step (1278) to retrieve the next substance. Once the final substance is retrieved and evaluated, it is determined in step (1278) to proceed to step (1280) to assign the worst compliance status of all substances to that specification for that composition. Referring Back to step (1264), if it is determined in step (1282) that the specification is not a fully disclosed composition, than it is determined in step (1284) whether the composition is an “all spec”. If so, then, in step (1290), each required substance in their requested specification is evaluated. In step (1292), it is determined whether the substance exists in the composition. If so, then, in step (1296), the process calculates substance compliance using the threshold value for the substance the requested specification. If this is not possible (rule (2)), than missing info status is assigned. The process than returns to step (1300) where the next substance is retrieved in step (1290). If, after step (1290), it is determined that a substance does not exist in a composition, then, in step (1298), it is determined that the substance does not exist in composition, than in step (1298), compliance status for the substance is set at missing information. The process then proceeds to step (1300) to the next substance. Referring back to step (1282), if it is determined that the composition is not an “all spec” in step (1286), than the composition is skipped in step (1288). Once the last substance is retrieved in step (1300), the worst compliance status of all substance to that specification for that composition is assigned in step (1283).

Referring to FIG. 17, the process of composition compliance is illustrated in a flowchart. First, in step (1302), the declaration work flow is advanced. In step (1304), the direct import of a composition into an item manufacturer part or part group is done. In step (1306), the composition compliance is evaluated. In step (1308), it is determined whether the composition has a bill of substances. If it does, then the process proceeds to step (1310) where the process calculates the mass and PPMs for all substances. In step (1312), the process calculates the mass and PPMs for all substance groups. In step (1314), the type of composition is assessed. Referring back to (1306), in step (1316) is determined whether the composition does not have a bill of substances. If it does not, than the process goes directly to step (1314), where the type of composition is assessed. After step (1314), it is first determined in step (1318) whether the composition has a specification attached. If it does, under the process calculates compliance of the composition. Then, the process proceeds to 2 steps. The process proceeds to step (1322) where it is determined whether the composition has a declared compliance. If it does, than the result compliance is the declared compliance as determined in step (1330). If, however, after step (1320), it is determined in step (1324) that the composition does not have a declared compliance, than the result compliance is blank as established in step (1332). Referring back to step (1314), if it is determined in step (1326) that the composition does not have a specification attached, than the calculated compliance of the composition is set as blank. The process then again proceeds to 2 steps. The process proceeds to step (1322) where it is determined whether the composition has a declared compliance. If so, than the result compliance has established the step (1330). If, however, it is determined that the composition does not have a declared compliance in step (1324), than the result compliance is established as blank in step (1332).

Referring to FIG. 18, the flowchart is illustrated of calculating mass and the PPM of substances. This is the same step of substances. This is the same step, step (1310), shown in FIG. 17. The first step, step (1334/1310), initiates the calculation of the mass and PPM for all substances in a composition. In step (1336), each substance in the composition is retrieved and the mass and PPM are calculated for each substance of the composition. In step (1338), it is determined whether the parent is not a substance group. If it is not, then the process proceeds to step (1340) where it is determined whether the substance mass and the mass of the parent are declared. If so, then the substance PPM is calculated in step (1342). After step (1342), it is determined whether the substance does not have a declared PPM in step (1344). If it does not, then the result PPM is equal to the calculated PPM as established in step (1346). The next substance is retrieved in step (1348). Referring back to step (1342), if it is determined that the substance has a declared PPM in step (1350), then the result PPM is set equal to the declared PPM. The next substance is then retrieved in step (1348). Referring back to step (1338), if it is determined in step (1354) that the substance or mass of the parent is undeclared, then the process proceeds to step (1356) where it is determined whether the parent mass and substance PPM are declared. If they are, then the substance mass is calculated in step (1358). Afterward, in step (1352), the resultant PPM is set equal to the declared PPM. The process then proceeds to step (1348) where the next substance is retrieved. Referring back to step (1354), if it is determined that the parent mass or substance PPM is undeclared in step (1360), then the process proceeds directly to step (1362) where the calculation is skipped and the mass is left blank. The process then proceeds to step (1348) for the next substance information. Referring back to step (1336), if it is determined that the parent is a substance group in step (1364), then the process bypasses the entire calculation process and goes to step (1348) where the next substance is evaluated. The process ends when the last calculation of mass and PPM for each substance is completed.

Referring to FIG. 19, a flow chart is illustrated of calculating the mass and PPM of substance groups. In step (1368/1312), the process is initiated for calculating mass and PPM for all substance groups in a composition. The process first proceeds to step (1370) where it is determined whether the substance group contains at least one substance. If so, then the process proceeds to step (1372) where the calculation is performed for each substance in the substance group in the composition. The process proceeds to two steps, first at (1374) where it is determined whether the substance has a conversion factor. If it does, then the process proceeds at step (1376) where the next substance is retrieved. Referring back to step (1372), it is determined in step (1378) whether the substance does not have a conversion factor. If it does not, then the process proceeds to step (1380) where it is determined whether a conversion factor exists in the (administration of B, G, and C) substance groups. With those, then the conversion factor field in the composition is left blank.

Referring back to step (1368), it is determined in step (1415) whether the substance group contains any substances. If it does not, then the process proceeds at step (1388). After steps (1386) and (1415), the process proceeds at step (1388), where the process determines that the calculation of the mass of the substance is left blank. After step (1376), where each substance is evaluated, the process then proceeds to step (1390), where the process sums of converted masses of the substance to calculate the mass of the substance group. After steps (1388) and (1390), the process proceeds to two different steps, steps (1392) and (1412). First, in step (1392), it is determined whether the substance group does not have a declared mass. If it does not, then the process proceeds to step (1394), where the resultant mass is established as equal. In step (1396), it is determined whether the substance group parent has a declared mass. If so, then, in step (1402), the process calculates substance group parts per million using the result mass. Then, in step (1404), it is determined whether the substance group has declared PPM. If so, the resultant PPM is declared PPM. If, however, the substance group does not have a declared PPM, then the process proceeds to step (1410) where the resultant PPM is determined to be the calculated PPM. Referring back to step (1394), the resultant mass is declared to be equal to the calculated mass, and the process proceeds to step (1398) where the substance group has a blank result mass or the parent has a blank declared mass. If this is true, then the process proceeds to step (1400) where the resultant PPM is left blank. Referring back to step (1412), if it is declared that the substance group has a declared mass, then the resultant mass is set equal to the declared mass in step (1414). The process then proceeds to step (1398). In either step (1388) or step (1390), the process proceeds to both steps (1392) and (1412). Similarly, in both steps (1394) and (1414), the process proceeds to steps (1396) and (1398) respectively.

Referring to FIG. 20, a flow chart is shown illustrating the assessment of the composition type. In the first, step (1416), the determination of the type of composition is initiated. In step (1418), it is determined whether the composition does not have a bill of substances (BOS). If it does not, then the composition is undisclosed. If, however, it is determined that the composition does have a BOS, in step (1422), then each material and sub-part is evaluated in step (1424) for assessment of a composition type. In step (1426), it is determined whether the composition does not have a declared mass. If it does not, then the composition is determined to be undisclosed in step (1420). If, however, the material has a declared mass, in step (1428), then the next material or sub-part is retrieved in step (1424). Once each material and sub-part has been assessed, then the process proceeds to step (1432), where each substance within a material or sub-part is evaluated, or each substance group is evaluated. In step (1434), it is determined whether the material or sub-part has a result mass. If it does not, then the process proceeds to step (1420) where the composition is deemed undisclosed. If, however, it is determined in step (1436) that the material or sub-part has a result mass, then the process proceeds to step (1448), where each material or sub-part is further evaluated in step (1432). Once each material or sub-part has been evaluated, the process proceeds to step (1550) and step (1466). In step (1450), for all BOS levels, the sum of the masses of the children is deemed to be equal to the weight of the parent within the mass error tolerance (please define). Then, in step (1452), the process validates that “miscellaneous (system)” substance is below the allowance. If the miscellaneous substance is below the allowance as determined in step 1454, then the composition is deemed to be fully disclosed in step (1456). If, however, the miscellaneous substance is determine to be above the allowance in step (1458), then the process proceeds to step (1460) where the process sets miscellaneous substance equal to the maximum allowance. Then, in step (1462), the process calculates and adds the unreported substance. Referring back to step (1466), it is determined whether at least for one of the BOS levels, the sum of the masses of the children is not equal to the weight of the parent within the mass error tolerance. If this is the case, the process proceeds directly to step (1462), where the process calculates and adds in reported substance. In step (1464), the composition is partially disclosed.

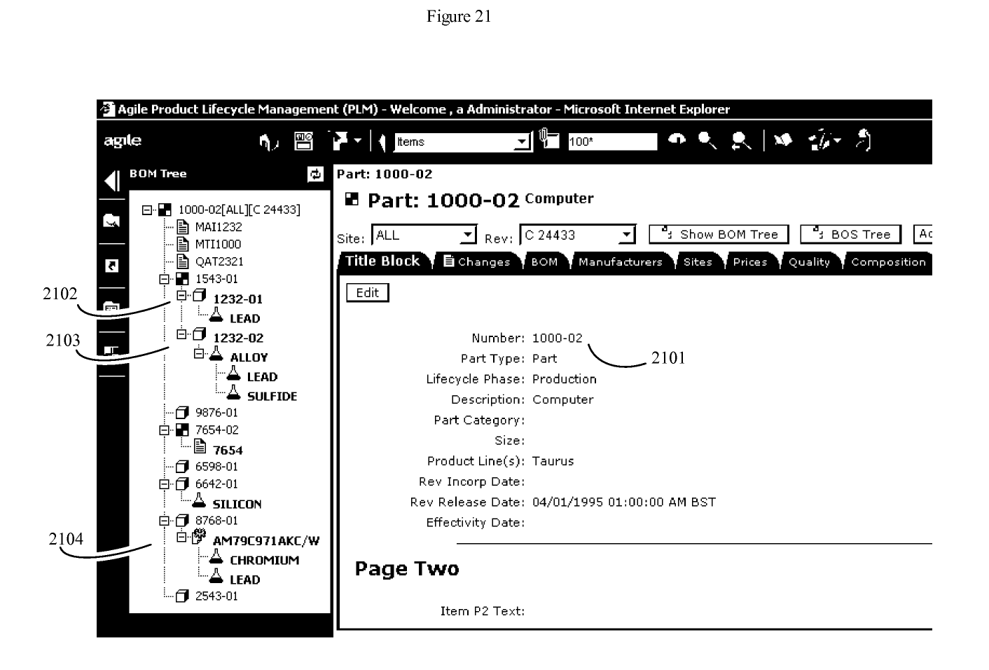

One of the biggest advantages of incorporating the material compliance technology of the invention into integrated product management systems, such as product lifecycle managers (PLM) systems, is that it makes it extremely easy for product designers, compliance managers, purchasing agents, and others in the organization to quickly inspect a product and almost instantly see what portions of the product are in compliance with a given set of regulations, and what portions are not. An example of a PLM user interface of a PLM system that incorporates the present art is shown in FIG. 21.

In FIG. 21, a very high level product, a complete computer (2101) has been called up and is being inspected. The bill of materials for this product is shown on the left. This bill of materials (BOM) has been set to display the component tree. Here each component is listed, and those components with regulatory issues, such as part 1231-01 (2102) (which has a regulatory problem with lead) and part 1232-02 (2103) (which has a problem because it is made of a lead containing alloy) can be seen at a glance. Note also that part AM79C971AKC/W (2104) has a problem with both chromium and lead. By contrast, consider how tedious and time consuming it would be to find out this information using prior art methods.

FIG. 22 gives an overview of how the PG&C software of the invention can be integrated into an overall product lifecycle manager (PLM).

The invention may involve a number of functions to be performed by one or more computer processors, such as microprocessors or older legacy mainframe computers. The microprocessor may be included in many different forms of computers such as servers and personal computers. The microprocessor may be a specialized or dedicated microprocessor that is configured to perform particular tasks by executing machine readable software code that defines the particular tasks. Applications, data processors, data generators, and other devices will be described that are embodied in a computer in the form of computer readable code that, when executed by a computer, configures the computer to perform the functions of these entities. The microprocessor may also be configured to operate and communicate with other devices such as direct memory access modules, memory storage devices, Internet related hardware, other computers and other devices that relate to the processing and transmission of data in accordance with the invention. The software code may be configured using software formats such as Java, C++, XML and other languages that may be used to define functions that relate to operations of devices required to carry out the functional operations of a computer that employs the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended Claims.

Within the different types of computers that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such servers for maintaining information that is frequently retrieved by a central processing unit, but that is not often altered within the persistent memory, unlike the cache memory. Main memory is also included in such servers for storing and retrieving larger amounts of information such as data and software applications configured to perform functions according to the invention when executed by the central processing unit. The main memory may be a disk drive or other volatile memory device. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The invention is described herein as a system for validating substance compliance of a product, where the system includes substance storage for storing substance related data used in a product and product storage configured to store data related to product components and substances that make up the respective components. The compliance may include one or more databases having data related to predetermined substance compliance criteria, and the system may further include a reuse engine, compliance engine and/or a roll-up engine configured to perform functions related to the invention, where the goal is improved systems and methods for managing, tracking, validating and otherwise dealing with material or substance compliance in products, including in component parts, packaging, enclosures, and other aspects of a product where evaluation of such materials and substances is desired or even required by government regulation. Although the description above uses language that is specific to structural features and/or methodological acts, it is to be understood that the invention defined in the appended Claims are not limited to the specific features or acts described. Rather, the specific features and acts are disclosed as exemplary forms of implementing the systems and methods discussed herein.

1. A system for validating substance compliance of a product, comprising:
substance storage for storing substance related data used in a product;
product storage configured to store data related to product components and substances that make up the respective components and materials used within the product;
a compliance database having data related to predetermined substance compliance criteria and exemptions;
a roll up engine configured to roll up product substance data and compliance status of a product of interest according to the data related to the product component information in the product storage and according to the corresponding product substance related data in the substance storage; and
a validity engine configured to determine whether the predetermined substance compliance criteria have been met.

2. A system according to claim 1, wherein the substance storage includes substance data related to product components and individual substances selected from the group consisting of substance that make up the components, substances used within a material to create a part through a stamping or molding process, and process materials used in the manufacturing of a process that will become part of the final product.

3. A system according to claim 2, wherein the substance storage further includes substance data related to product packaging and individual substances that make up the product packaging.

4. A system according to claim 2, wherein the roll up engine is configured to generate substance quantity values that pertain to the amount of individual substances contained in a product.

5. A system according to claim 4, wherein the roll up engine is configured to generate substance quantity values that pertain to the weight of individual substances contained in a product, or substance quantity on a parts-per-million basis.

6. A system according to claim 1, wherein the validity engine is configured to ascertain the amount of a substance of interest in a product, component, or material, and to compare the ascertained amount of the substance to a predetermined compliance threshold to determine whether the product, component, or material is compliant with respect to the substance of interest.

7. A system according to claim 6, wherein the validity engine is further configured to calculate a best case amount of a substance and a worst case amount of a substance contained in a product for comparison with the compliance threshold.

8. A system according to claim 7, wherein the validity engine is further configured to calculate a best case amount of a substance and a worst case amount of a substance contained in a product, component, or material for comparison with the compliance threshold, and is further configured to generate a request for a compliance corrective action if the amount of the substance contained in the product is above a predetermined threshold.

9. A system for validating substance compliance of a product, comprising:
substance storage for storing substance related data used in a product;
product storage configured to store data related to product components and substances that make up the respective components;
product storage configured to store data related to materials and substances that make up the respective materials;
a reuse database having data related to predetermined substance compliance criteria of individual components and materials;
a reuse tracker configured to track substances contained in a component; and
a validity engine configured to determine whether the predetermined substance compliance criteria have been met.

10. A system according to claim 9, wherein the reuse database is configured to ascertain component or material substance quantities that are unknown.

11. A system according to claim 9, wherein the reuse database is configured to ascertain component or material substance quantities according to predetermined statements made by the component producer.

12. A system for validating substance compliance of a product, comprising:
substance storage for storing substance related data used in a product;
product storage configured to store data related to product components and substances that make up the respective components;
a compliance database having data related to substance compliance criteria of individual components, the compliance database including
a compliance corrective action engine configured to generate change orders when a component is determined to not be compliant; and
a validity engine configured to determine whether the predetermined substance compliance criteria have been met, and also configured to calculate a best case amount of a substance and a worst case amount of a substance contained in a product for comparison with the compliance threshold, and is further configured to cause the compliance corrective action engine to generate a request for a compliance corrective action if the amount of the substance contained in the product is above a predetermined threshold.

13. An integrated system for improved product substance compliance that links material substance data with one or more material substance regulatory requirements data, and in turn links the substance data and the regulatory requirements data with product lifecycle management data, the system comprising:
one or more servers, the servers comprising memory and a processor,
one or more databases capable of exchanging data with the servers,
one or more networks connected to the servers, the networks capable of allowing
the servers to exchange data with each other and with remote computers connected to the networks;
product lifecycle management software running on at least some of the servers, the product lifecycle management software capable of managing at least a plurality of items from a bill of materials for a product;
product governance and compliance software running on at least some of the servers, wherein the product governance and compliance software determines the regulatory compliance of the items from the bill of materials for the product;
wherein the integrated system determines the regulatory compliance of the product by rollup algorithms that examine the regulatory compliance of the items from the bill of materials for the product.

14. The system of claim 13, in which the material substance data is compliant with the standards selected from the group consisting of IPC-1752 standards, Japanese Green Procurement (JGPSSI) standards, RosettaNet PIPs 2A10 and 2A13 standards, and National Electronics Distributor Association (NEDA) standards; and is entered by electronic data files consistent with these standards.

15. The system of claim 13, in which the material substance that is being monitored includes substances selected from the group consisting of lead, cadmium, mercury, hexavalent chromium, polybrominated biphenyl (PBB), and polybrominated diphenyl ether (PBDE) flame retardants, Joint Industry Guide (JIG) A, B, C lists, or custom substance lists.

16. The system of claim 13, in which the system monitors regulatory compliance of a product by algorithms selected from the group consisting of summing up supplier declarations of conformity for the various items from the bill of materials for the product, and summing up the bill of substances in the items from the bill of materials for the product, and comparing the bill of substances with one or more regulatory requirements data from the system.

17. The system of claim 13, in which the material substance data includes the American Chemical Society CAS registry number for at least one chemical in the material.

18. The system of claim 13, in which the material substance regulatory requirements are chosen from the group consisting of the European Union's Restriction of Hazardous Substances regulations, the Waste from Electrical and Electronic Equipment requirements, the Chinese Regulation for Pollution Control of Electronic Products, or the California Waste Recycling act, or Joint Industry Guide (JIG) A, B, and C lists.

19. The system of claim 13, in which the product lifecycle management software of the system makes the regulatory compliance status of each item in a bill of materials or a proposed bill of materials for a product or proposed product available to product designers, compliance managers, purchasing managers, manufacturing managers, regulatory managers and accounting managers.

20. The system of claim 13, in which the product lifecycle management software manages database elements that comprise data selected from the group consisting of product data, supply chain data, component part data, subcontracting company data, partnership data, design data, development data, access privilege data, trade secret data, confidential information data, business relationship data, business documents data, business agreements data, OEM products and components data, CEM products and components data, bill of material data, change order data, component part object data, component part linking data, component part identification data, component part number data, part attribute data, part affiliation data, part product context data, specifications drawing data, color data, size data, type data, price data, quantity data, find number data, cross-reference data, related information data, earlier version data, history of change data, text document data, graphics drawing data, other attribute data, redacted data, discovery privilege data, cost data, component parts specifications data, product specifications data, quantity received data, quantity needed data, availability data, supplier type data, geographical information, and purchase order data, program data, schedule data, resources data, critical path data, activities data, issues data, action items data, task data assignment data reports data and product deliverables data.

21. A method for integrating product environmental regulatory compliance data into product lifecycle management software, the method comprising:
obtaining a bill of materials for a product, the product consisting of a plurality of parts, each part being composed of materials that may contain one or more substances subject to environmental regulation;
obtaining declarations of either conformity to environmental regulations or substance composition data for each of the plurality of parts from the suppliers of the parts;
obtaining regulatory data regarding the amount of the substances that are allowed by one or more environmental product regulations;
inputting the bill of materials the declarations of conformity or the substance composition data and the regulatory data into a computer database;
providing one or more computerized rollup algorithms to the computer database, wherein the rollup algorithms traverse the bill of materials and compute compliance of the product with the environmental declarations by comparing the declarations of conformity or the substance composition data with the environmental regulations;
wherein the product lifecycle management software routinely exposes the results of such regulatory compliance computations alongside the results from its other product lifecycle functionality.

22. The method of claim 21, wherein the product lifecycle management system resides on a computerized network comprising:
one or more servers, the servers comprising memory and a processor,
one or more databases capable of exchanging data with the servers,
one or more networks connected to the servers, the networks capable of allowing the servers to exchange data with each other and with remote computers connected to the networks;
wherein the product lifecycle management system runs on at least some of the servers, and the product lifecycle management system is capable of managing at a plurality of items from a bill of materials for a product.

23. The method of claim 21, in which the declarations of conformity or the material substance data is compliant with standards selected from the group consisting of IPC-1752 standards, Japanese Green Procurement (JGPSSI) standards, RosettaNet PIPs 2A10 and 2A13 standards, and National Electronics Distributor Association (NEDA) standards; and is entered by electronic data files consistent with these standards.

24. The method of claim 21, in which the material substance that is being monitored includes substances selected from the group consisting of lead, cadmium, mercury, hexavalent chromium, polybrominated biphenyl (PBB), and polybrominated diphenyl ether (PBDE) flame retardants, Joint Industry Guide (JIG) A, B, C lists, or custom substance lists.

25. The method of claim 21, in which the rollup algorithms are selected from the group consisting of summing up supplier declarations of conformity for the various items from the bill of materials for the product, and summing up the bill of substances in the items from the bill of materials for the product, and comparing the bill of substances with one or more regulatory requirements data from the system.

26. The method of claim 21, in which the substance composition data includes the American Chemical Society CAS registry number for at least one chemical in the substance.

27. The method of claim 21, in which the regulatory data is chosen from the group consisting of the European Union's Restriction of Hazardous Substances regulations, the Waste from Electrical and Electronic Equipment requirements, the Chinese Regulation for Pollution Control of Electronic Products, the California Waste Recycling act, or Joint Industry Guide (JIG) A, B, and C lists.

28. The method of claim 21, in which the product lifecycle management functionality includes product design functionality, regulatory compliance functionality, purchasing functionality, manufacturing management functionality, sales functionality, marketing functionality, accounting functionality, portfolio management functionality, program management functionality, resource management functionality, or cost management functionality.

29. The method of claim 21, in which the product lifecycle management software manages database elements that comprise data selected from the group consisting of product data, supply chain data, component part data, subcontracting company data, partnership data, design data, development data, access privilege data, trade secret data, confidential information data, business relationship data, business documents data, business agreements data, OEM products and components data, CEM products and components data, bill of material data, change order data, component part object data, component part linking data, component part identification data, component part number data, part attribute data, part affiliation data, part product context data, specifications drawing data, color data, size data, type data, price data, quantity data, find number data, cross-reference data, related information data, earlier version data, history of change data, text document data, graphics drawing data, other attribute data, redacted data, discovery privilege data, cost data, component parts specifications data, product specifications data, quantity received data, quantity needed data, availability data, supplier type data, geographical information, purchase order data, program data, schedule data, resources data, critical path data, activities data, issues data, action items data, task data assignment data reports data and product deliverables data.
